(19) United States
(12) Patent Application Publication
(10) Pub. No.: US 2024/0241408 A1
(43) Pub. Date: Jul. 18, 2024

(54) LIQUID CRYSTAL DISPLAY PANEL AND DISPLAY APPARATUS

(71) Applicants: BEIJING BOE DISPLAY TECHNOLOGY CO., LTD., Beijing (CN); BOE TECHNOLOGY GROUP CO., LTD., Beijing (CN)

(72) Inventors: Jianhua HUANG, Beijing (CN); Lingdan BO, Beijing (CN); Yingying QU, Beijing (CN); Dongchuan CHEN, Beijing (CN); Ting DONG, Beijing (CN); Xiaohan TIAN, Beijing (CN); Tianyang HAN, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 18/044,492

(22) PCT Filed: May 27, 2022
(86) PCT No.: PCT/CN2022/095683

§ 371 Date: Mar. 8, 2023

(51) Int. Cl. G02F 1/13363; G02F 1/1335

(52) U.S. Cl. CPC G02F 1/133638; G02F 1/133531

(57) ABSTRACT

A liquid crystal display panel includes a first polarizer, a second polarizer arranged opposite to the first polarizer, a liquid crystal layer, a first optical compensation layer and a second optical compensation layer. Transmission axes of the first polarizer and the second polarizer are perpendicular to each other. An orthographic projection of an optical axis of the first optical compensation layer on the first polarizer is parallel to the transmission axis of the first polarizer. An optical axis of the second optical compensation layer is perpendicular to a plane where the second optical compensation layer is located. An in-plane retardation R_{O1} of the first optical compensation layer and an in-plane retardation R_{OLC} of the liquid crystal layer satisfy a formula: R_{O1}=n₁×R_{OLC}+m₁λ₁, in which m₁ is an integer, n₁ is in a range of ¼ to ¾, inclusive, and λ₁ is in a range of 390 nm to 780 nm, inclusive.

### CROSS-REFERENCE TO RELATED APPLICATION

This application is a national phase entry under 35 USC 371 of International Patent Application No. PCT/CN 2022/095683 filed on May 27, 2022, which is incorporated herein by reference in its entirety.

### TECHNICAL FIELD

The present disclosure relates to the field of display technologies, and in particular, to a liquid crystal display panel and a display apparatus.

### BACKGROUND

Liquid crystal displays (LCDs) have characteristics of small size, low power consumption and no radiation, and are currently a widely used type of displays.

### SUMMARY

In an aspect, a liquid crystal display panel is provided. The liquid crystal display panel includes a first polarizer, a second polarizer, a liquid crystal layer, a first optical compensation layer and a second optical compensation layer. The second polarizer is arranged opposite to the first polarizer. A transmission axis of the first polarizer is perpendicular to a transmission axis of the second polarizer. The first polarizer is closer to a light incident side of the liquid crystal display panel than the second polarizer. The liquid crystal layer is disposed between the first polarizer and the second polarizer, and includes liquid crystal molecules. Orthographic projections of optical axes of the liquid crystal molecules on the first polarizer are parallel to the transmission axis of the first polarizer, or are parallel to the transmission axis of the second polarizer. The first optical compensation layer and the second optical compensation layer are stacked between the first polarizer and the liquid crystal layer or between the liquid crystal layer and the second polarizer. An orthographic projection of an optical axis of the first optical compensation layer on the first polarizer is parallel to the transmission axis of the first polarizer. An optical axis of the second optical compensation layer is perpendicular to a plane where the second optical compensation layer is located. An in-plane retardation R_{O1} of the first optical compensation layer and an in-plane retardation R_{OLC} of the liquid crystal layer satisfy a following formula: R_{O1}=n₁×R_{OLC}+m₁λ₁, in which m₁ is an integer, n₁ is in a range of ¼ to ¾, inclusive, and λ₁ is in a range of 390 nm to 780 nm, inclusive.

In some embodiments, a value of n₁ is 2.

In some embodiments, the first optical compensation layer is an optical compensation layer with a single optical axis, and the second optical compensation layer is disposed on a side of the first optical compensation layer away from the first polarizer.

In some embodiments, the in-plane retardation R_{O1} of the first optical compensation layer is in a range of 105 nm to 145 nm, inclusive. A thickness direction retardation Rₜₕ₁ of the first optical compensation layer is in a range of 42.5 nm to 82.5 nm, inclusive.

In some embodiments, a thickness direction retardation Rₜₕ₂ of the second optical compensation layer and the in-plane retardation R_{OLC} of the liquid crystal layer satisfy a following formula: Rₜₕ₂=n₂×R_{OLC}+m₂λ₂, in which m₂ is an integer, n₂ is in a range of

$$- \frac{6 + π}{6 π} to - \frac{6 - π}{6 π} ,$$

inclusive, and λ₂ is in the range of 390 nm to 780 nm, inclusive.

In some embodiments, a value of n₂ is

$$- \frac{1}{π} .$$

In some embodiments, a thickness direction retardation Rₜₕ₂ of the second optical compensation layer is in a range of −100 nm to −60 nm, inclusive.

In some embodiments, the first optical compensation layer is a +A compensation film layer, and the second optical compensation layer is a +C compensation film layer.

In some embodiments, the second optical compensation layer is disposed on a side of the first optical compensation layer proximate to the first polarizer. The first optical compensation layer is an optical compensation layer with two optical axes. One of the two optical axes is a first optical axis, and a length of the first optical axis is greater than a length of another one of the two optical axes. An orthographic projection of the first optical axis on the first polarizer is parallel to the transmission axis of the first polarizer.

In some embodiments, the in-plane retardation R_{O1} of the first optical compensation layer is in a range of 95 nm to 135 nm, inclusive. A thickness direction retardation Rₜₕ₁ of the first optical compensation layer is in a range of −130 nm to −90 nm, inclusive.

In some embodiments, a thickness direction retardation Rₜₕ₂ of the second optical compensation layer and the in-plane retardation R_{OLC} of the liquid crystal layer satisfy a following formula: Rₜₕ₃=n₃×R_{OLC}+m₃λ₃, in which m₃ is an integer, n₃ is in a range of

$$- \frac{6 - π}{6 π} to \frac{6 + π}{6 π} ,$$

inclusive, and λ₃ is in the range of 390 nm to 780 nm, inclusive.

In some embodiments, a value of n₃ is

$$\frac{1}{π} .$$

In some embodiments, a thickness direction retardation Rₜₕ₂ of the second optical compensation layer is in a range of 90 nm to 130 nm, inclusive.

In some embodiments, the first optical compensation layer is a +B compensation film layer, and the second optical compensation layer is a −C compensation film layer.

In another aspect, a display apparatus is provided. The display apparatus includes a backlight module and the liquid crystal display panel as described above. The liquid crystal display panel is disposed on a light exit side of the backlight module.

In some embodiments, a value of m₁ is 0.

In some embodiments, the in-plane retardation R_{O1} of the first optical compensation layer is in a range of a difference between 125 nm and 15 nm to a sum of 125 nm and 15 nm, a difference between 125 nm and 10 nm to a sum of 125 nm and 10 nm, a difference between 125 nm and 5 nm to a sum of 125 nm and 5 nm, or a difference between 125 nm and 2 nm to a sum of 125 nm and 2 nm. The thickness direction retardation Rₜₕ₁ of the first optical compensation layer is in a range of a difference between 62.5 nm and 15 nm to a sum of 62.5 nm and 15 nm, a difference between 62.5 nm and 10 nm to a sum of 62.5 nm and 10 nm, a difference between 62.5 nm and 5 nm to a sum of 62.5 nm and 5 nm, or a difference between 62.5 nm and 2 nm to a sum of 62.5 nm and 2 nm.

In some embodiments, a value of m₂ is 0.

In some embodiments, the thickness direction retardation Rₜₕ₂ of the second optical compensation layer is in a range of a difference between −80 nm and 15 nm to a sum of −80 nm and 15 nm, a difference between −80 nm and 10 nm to a sum of −80 nm and 10 nm, a difference between −80 nm and 5 nm to a sum of −80 nm and 5 nm, or a difference between −80 nm and 2 nm to a sum of −80 nm and 2 nm.

In some embodiments, a value of m₃ is 0.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, and are not limitations on an actual size of a product, an actual process of a method and an actual timing of a signal involved in the embodiments of the present disclosure.

FIG. 1A is a structural diagram of a display apparatus, in accordance with some embodiments;

FIG. 1B is a structural diagram of a liquid crystal display panel, in accordance with some embodiments;

FIG. 1C is a diagram showing a relative positional relationship between a first polarizer and a second polarizer, in accordance with some embodiments;

FIG. 1D is a structural diagram of a liquid crystal display panel, in accordance with some other embodiments;

FIG. 1E is a structural diagram of a liquid crystal display panel, in accordance with yet other embodiments;

FIG. 1F is a structural diagram of a liquid crystal layer, in accordance with some embodiments;

FIG. 2A is a structural diagram of a liquid crystal display panel, in accordance with yet other embodiments;

FIG. 2B is a structural diagram of a liquid crystal display panel, in accordance with yet other embodiments;

FIG. 2C is a diagram showing a relative positional relationship between a transmission axis of a first polarizer and a transmission axis of a second polarizer at a side viewing angle;

FIG. 2D is a distribution diagram of a contrast ratio at a full viewing angle;

FIG. 2E is a diagram showing positions of light on the Poincaré sphere at a side viewing angle;

FIG. 3A is a structural diagram of a liquid crystal display panel, in accordance with yet other embodiments;

FIG. 3B is a structural diagram of a liquid crystal display panel, in accordance with yet other embodiments;

FIG. 3C is a diagram showing positions of light on the Poincaré sphere at a side viewing angle, in accordance with some other embodiments;

FIG. 3D is a diagram showing positions of light on the Poincaré sphere at a side viewing angle, in accordance with yet other embodiments;

FIG. 3E is a structural diagram of a second optical compensation layer, in accordance with some embodiments;

FIG. 4A is a structural diagram of a liquid crystal display panel, in accordance with yet other embodiments;

FIG. 4B is a structural diagram of a liquid crystal display panel, in accordance with yet other embodiments;

FIG. 4C is a structural diagram of a liquid crystal display panel, in accordance with yet other embodiments;

FIG. 4D is a structural diagram of a liquid crystal display panel, in accordance with yet other embodiments;

FIG. 4E is a structural diagram of a liquid crystal display panel, in accordance with yet other embodiments;

FIG. 4F is a structural diagram of a liquid crystal display panel, in accordance with yet other embodiments;

FIG. 5A is a distribution diagram of a contrast ratio at a full viewing angle, in accordance with some other embodiments;

FIG. 5B is a graph of a light leakage brightness at a side viewing angle, in accordance with some embodiments;

FIG. 6A is a structural diagram of a liquid crystal display panel, in accordance with yet other embodiments;

FIG. 6B is a structural diagram of a liquid crystal display panel, in accordance with yet other embodiments;

FIG. 6C is a diagram showing positions of light on the Poincaré sphere at a side viewing angle, in accordance with yet other embodiments;

FIG. 6D is a diagram showing positions of light on the Poincaré sphere at a side viewing angle, in accordance with yet other embodiments; and

FIG. 6E is a distribution diagram of a contrast ratio at a full viewing angle, in accordance with yet other embodiments.

### DETAILED DESCRIPTION

Technical solutions in some embodiments of the present disclosure will be described clearly and completely below with reference to the accompanying drawings. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to.” In the description of the specification, the terms such as “one embodiment,” “some embodiments,” “exemplary embodiments,” “an example,” “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms such as “first” and “second” are only used for descriptive purposes, and are not to be construed as indicating or implying relative importance or implicitly indicating the number of indicated technical features. Thus, a feature defined with “first” or “second” may explicitly or implicitly include one or more of the features. In the description of the embodiments of the present disclosure, the term “a plurality of/the plurality of” means two or more unless otherwise specified.

The phrase “at least one of A, B and C” has the same meaning as the phrase “at least one of A, B or C”, both including following combinations of A, B and C: only A, only B, only C, a combination of A and B, a combination of A and C, a combination of B and C, and a combination of A, B and C.

The phrase “A and/or B” includes following three combinations: only A, only B, and a combination of A and B.

As used herein, the term such as “about,” “substantially” or “approximately” includes a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

As used herein, the term such as “parallel,” “perpendicular” or “equal” includes a stated condition and condition(s) similar to the stated condition. The similar condition(s) are within an acceptable range of deviation as determined by a person of ordinary skill in the art, considering measurement in question and errors associated with measurement of a particular quantity (i.e., limitations of a measurement system). For example, the term “parallel” includes “absolutely parallel” and “approximately parallel,” and for the phrase “approximately parallel,” an acceptable range of deviation may be, for example, within 5°. The term “perpendicular” includes “absolutely perpendicular” and “approximately perpendicular,” and for the phrase “approximately perpendicular,” an acceptable range of deviation may also be, for example, within 5°. The term “equal” includes “absolutely equal” and “approximately equal,” and for the phrase “approximately equal,” an acceptable range of deviation may be that, for example, a difference between two that are equal to each other is less than or equal to 5% of any one of the two.

It will be understood that when a layer or element is described as being on another layer or substrate, the layer or element may be directly on the another layer or substrate, or intermediate layer(s) may exist between the layer or element and the another layer or substrate.

Exemplary embodiments are described herein with reference to sectional views and/or plan views as idealized exemplary drawings. In the accompanying drawings, thicknesses of layers and sizes of regions are enlarged for clarity. Thus, variations in shape relative to the accompanying drawings due to, for example, manufacturing techniques and/or tolerances may be envisaged. Therefore, the exemplary embodiments should not be construed to be limited to the shapes of regions shown herein, but to include deviations in shape due to, for example, manufacturing. For example, an etched region shown in a rectangular shape generally has a curved feature. Therefore, the regions shown in the accompanying drawings are schematic in nature, and their shapes are not intended to show actual shapes of the regions in a device, and are not intended to limit the scope of the exemplary embodiments.

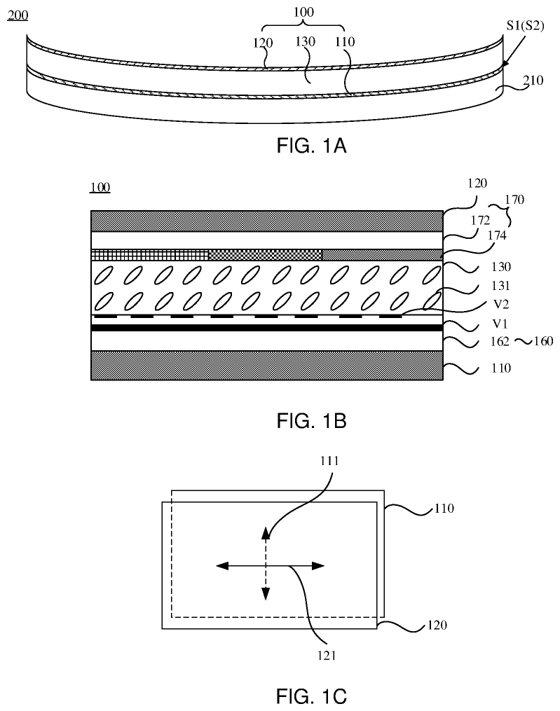

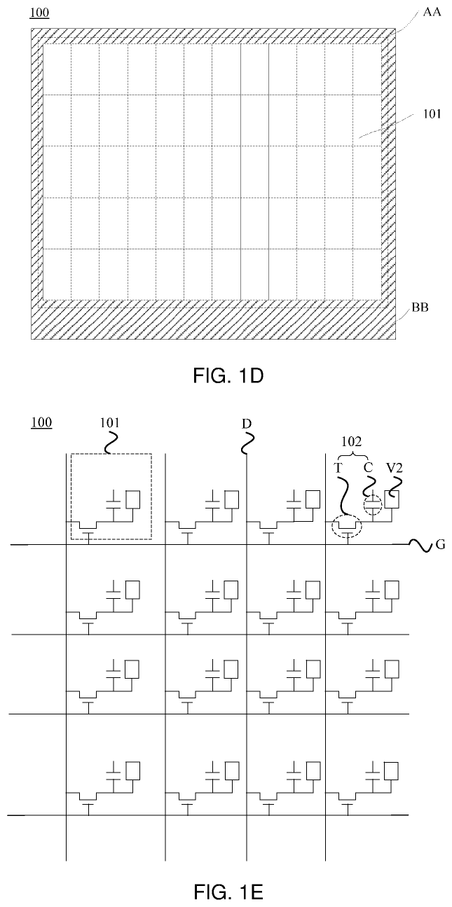

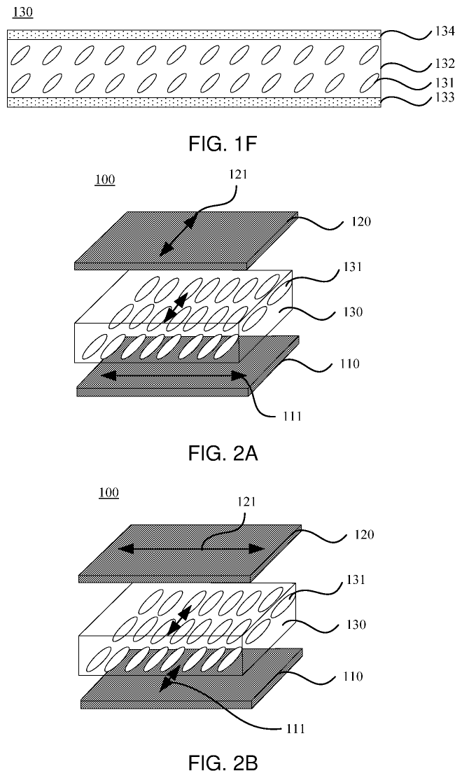

FIG. 1A is a structural diagram of a display apparatus, in accordance with some embodiments.

As shown in FIG. 1A, embodiments of the present disclosure provide a display apparatus 200. For example, the display apparatus 200 may be any apparatus that displays images whether moving (e.g., videos) or stationary (e.g., still images), and whether literal or pictorial. The display apparatus 200 may include a variety of display apparatuses 200. The variety of display apparatuses 200 are, for example (but not limit to), mobile phones, wireless devices, personal data assistants (PDAs), hand-held or portable computers, global positioning system (GPS) receivers/navigators, cameras, MPEG-4 Part 14 (MP4) video players, camcorders, game consoles, flat panel displays, computer monitors, auto displays (e.g., car driving recorder or car back-up camera).

In some embodiments, as shown in FIG. 1A, the display apparatus 200 includes a backlight module 210 and a liquid crystal display panel 100. The liquid crystal display panel 100 is disposed on a light exit side M2 of the backlight module 210.

It will be understood that the backlight module 210 is used for providing a light source to the liquid crystal display panel 100 for display, so that the display apparatus 200 is able to realize an image display function.

In some examples, the backlight module 210 may be a direct-type backlight module or a side-type backlight module. The backlight module 210 is not limited in the embodiments of the present disclosure. The liquid crystal display panel 100 will be exemplarily described below.

In some embodiments, as shown in FIG. 1A, the liquid crystal display panel 100 includes a first polarizer 110, a second polarizer 120 and a liquid crystal layer 130. The second polarizer 120 and the first polarizer 110 are arranged opposite to each other. A transmission axis 111 of the first polarizer 110 is perpendicular to a transmission axis 121 of the second polarizer 120. The liquid crystal layer 130 is disposed between the first polarizer 110 and the second polarizer 120.

It will be understood that a polarizer (e.g., the first polarizer 110 or the second polarizer 120) has an absorption axis and a transmission axis, and the absorption axis is perpendicular to or approximately perpendicular to the transmission axis. When light reaches the polarizer, a component of the light in a direction parallel to or approximately parallel to the transmission axis is able to pass through the polarizer, and a component of the light in a direction parallel to or approximately parallel to the absorption axis is unable to pass through the polarizer. That is, the polarizer is able to convert the light into linearly polarized light with a polarization direction parallel to or approximately parallel to the transmission axis.

It will be understood that in a case where the light reaching the polarizer has no component in the direction parallel to or approximately parallel to the transmission axis, i.e., in a case where a polarization direction of the light reaching the polarizer is parallel to or approximately parallel to the absorption axis, the light cannot pass through the polarizer.

FIG. 1B is a structural diagram of a liquid crystal display panel, in accordance with some embodiments. FIG. 1C is a diagram showing a relative positional relationship between a first polarizer and a second polarizer, in accordance with some embodiments.

The first polarizer 110 and the second polarizer 120 are arranged opposite to each other. That is, the first polarizer 110 is spaced apart from the second polarizer 120, and an orthographic projection of the first polarizer 110 on the liquid crystal layer 130 is at least partially overlapped with an orthographic projection of the second polarizer 120 on the liquid crystal layer 130. In some examples, the orthographic projection of the first polarizer 110 on the liquid crystal layer 130 coincides with or approximately coincides with the orthographic projection of the second polarizer 120 on the liquid crystal layer 130.

It can be seen from the above that the liquid crystal display panel 100 is disposed on the light exit side of the backlight module 210. In some examples, as shown in FIG. 1A, the first polarizer 110 is closer to the light exit side of the backlight module 210 than the second polarizer 120. That is, light emitted from the backlight module 210 reaches the liquid crystal display panel 100 in a direction from the first polarizer 110 to the second polarizer 120, so that the first polarizer 110 may be closer to a light incident side M1 of the liquid crystal display panel 100 than the second polarizer 120.

In some other examples, the first polarizer 110 is farther from the light exit side of the backlight module 210 than the second polarizer 120. That is, the light emitted from the backlight module 210 reaches the liquid crystal display panel 100 in a direction from the second polarizer 120 to the first polarizer 110, so that the first polarizer 110 may be farther from the light incident side of the liquid crystal display panel 100 than the second polarizer 120.

For the convenience of description, in the embodiments of the present disclosure, a description will be made in an example where the first polarizer 110 is closer to the light incident side of the liquid crystal display panel 100 than the second polarizer 120.

It will be understood that the light emitted from the backlight module 210 is directed to a display side of the liquid crystal display panel 100. That is, in a case where the first polarizer 110 is closer to the light incident side of the liquid crystal display panel 100 than the second polarizer 120, the first polarizer 110 is farther from the display side of the liquid crystal display panel 100 than the second polarizer 120.

As shown in FIG. 1C, the transmission axis 111 of the first polarizer 110 is perpendicular to the transmission axis 121 of the second polarizer 120. That is, an orthographic projection of the transmission axis 121 of the second polarizer 120 on the first polarizer 110 is perpendicular to or approximately perpendicular to the transmission axis 111 of the first polarizer 110.

It will be understood that when the light emitted from the backlight module 210 reaches the first polarizer 110, a polarization direction of light passing through the first polarizer 110 is parallel to or approximately parallel to the transmission axis 111 of the first polarizer 110, and the transmission axis 111 of the first polarizer 110 is perpendicular to the transmission axis 121 of the second polarizer 120, so that linearly polarized light passing through the first polarizer 110 has no component in a direction parallel to or approximately parallel to the transmission axis 121 of the second polarizer 120. That is, the linearly polarized light passing through the first polarizer 110 cannot pass through the second polarizer 120.

As shown in FIGS. 1A and 1B, the liquid crystal layer 130 is disposed between the first polarizer 110 and the second polarizer 120. As shown in FIG. 1B, the liquid crystal layer 130 includes liquid crystal molecules 131. It will be understood that a polarization direction of the linearly polarized light passing through the first polarizer 110 may be changed by changing a deflection angle of the liquid crystal molecules 131, so that the linearly polarized light passing through the first polarizer 110 is able to have at least a partial component in the direction parallel to or approximately parallel to the transmission axis 121 of the second polarizer 120. That is, at least part of the linearly polarized light passing through the first polarizer 110 is able to pass through the second polarizer 120.

It will be understood that an intensity of light passing through the second polarizer 120 is able to be controlled by controlling the deflection angle of the liquid crystal molecules 131, so that the liquid crystal display panel 100 is able to realize the image display function.

FIG. 1D is a structural diagram of a liquid crystal display panel, in accordance with some other embodiments. FIG. 1E is a structural diagram of a liquid crystal display panel, in accordance with yet other embodiments. The liquid crystal display panel 100 will continue to be exemplarily described with reference to FIGS. 1B to 1E below.

In some examples, as shown in FIG. 1B, the liquid crystal display panel 100 includes an array substrate 160 and an opposite substrate 170. The array substrate 160 and the opposite substrate 170 are arranged opposite to each other, and are disposed between the first polarizer 110 and the second polarizer 120.

For example, in the case where the first polarizer 110 is closer to the light incident side of the liquid crystal display panel 100 than the second polarizer 120, the array substrate 160 is closer to the first polarizer 110 than the opposite substrate 170. The liquid crystal layer 130 is disposed between the array substrate 160 and the opposite substrate 170.

In some examples, as shown in FIG. 1D, the liquid crystal display panel 100 has a display area AA and a peripheral area BB. For example, the peripheral area BB surrounds the display area AA. It will be noted that the dashed box in FIG. 1D is merely for convenience of showing the display area AA, and does not further limit the display area AA.

The liquid crystal display panel 100 includes a plurality of sub-pixels 101 disposed in the display area AA of the liquid crystal display panel 100. The plurality of sub-pixels 101 are arranged in an array, so that the liquid crystal display panel 100 is able to realize the image display function. It will be understood that the number of the sub-pixels 101 is not limited in the embodiments of the present disclosure.

As shown in FIG. 1E, the sub-pixel 101 includes a pixel driving circuit 102 and a pixel electrode V2, and the pixel driving circuit 102 is electrically connected to the pixel electrode V2. For example, the liquid crystal display panel 100 further includes a plurality of gate lines G and a plurality of data lines D. A gate line G is electrically connected to pixel driving circuits 102 in a row of sub-pixels 101, and a data line D is electrically connected to pixel driving circuits 102 in a column of sub-pixels 101.

For example, as shown in FIG. 1E, the pixel driving circuit 102 includes a thin film transistor (TFT) T and a storage capacitor C. The gate line G is electrically connected to a gate of the thin film transistor T, and the data line D is electrically connected to a source of the thin film transistor T.

In some examples, as shown in FIG. 1B, the array substrate 160 includes a first substrate 162. The plurality of gate lines G, the plurality of data lines D, the pixel driving circuits 102 and the pixel electrodes V2 are all disposed on a side of the first substrate 162. For example, a material of the first substrate 162 includes glass.

As shown in FIG. 1B, the liquid crystal display panel 100 further includes a common electrode V1. Each pixel electrode V2 and the common electrode V1 may form an electric field therebetween. By controlling a voltage value of each pixel electrode V2, a strength of the electric field formed between each pixel electrode V2 and the common electrode V1 is able to be controlled, thereby controlling the deflection angle of the liquid crystal molecules 131 in the liquid crystal layer 130.

In some examples, as shown in FIG. 1B, the common electrode V1 is also disposed on the side of the first substrate 162. For example, the common electrode V1 may be closer to the first substrate 162 than the pixel electrodes V2.

In some examples, the common electrode V1 is a plate electrode, and the pixel electrode V2 is a strip electrode. In some other examples, the pixel electrode V2 may be a comb-tooth electrode.

In some examples, the liquid crystal display panel 100 may be a liquid crystal display panel with an advanced super dimension switch (ADS) display mode. Alternatively, the liquid crystal display panel 100 may be a liquid crystal display panel with an in-plane switching (IPS) display mode.

In some examples, as shown in FIG. 1B, the liquid crystal display panel 100 further includes the opposite substrate 170. The opposite substrate 170 includes a second substrate 172 and a filter film 174. The filter film 174 is disposed on a side of the second substrate 172. For example, as shown in FIG. 1B, the filter film 174 is disposed on a side of the second substrate 172 proximate to the liquid crystal layer 130.

For example, the filter film 174 includes red filter films, green filter films and blue filter films. Light passing through the first polarizer 110 and the liquid crystal layer 130 reaches the filter film 174, and then is able to be filtered into red light, green light and blue light by the filter film 174. The red light, the green light and the blue light exit from the second polarizer 120.

It will be understood that an intensity of the red light that exit from the second polarizer 120 is able to be controlled by adjusting an intensity of light reaching the red filter films, an intensity of the green light that exit from the second polarizer 120 is able to be controlled by adjusting an intensity of light reaching the green filter films, and an intensity of the blue light that exit from the second polarizer 120 is able to be controlled by adjusting an intensity of light reaching the blue filter films, so that the liquid crystal display panel 100 is able to realize full color image display.

FIG. 1F is a structural diagram of a liquid crystal layer, in accordance with some embodiments. The liquid crystal layer 130 will be exemplarily described with reference to FIG. 1F below.

In some examples, as shown in FIG. 1F, the liquid crystal layer 130 includes a liquid crystal molecular layer 132, and the liquid crystal molecules 131 are disposed in the liquid crystal molecular layer 132.

It will be understood that the liquid crystal molecule 131 is a single-optical-axis crystal, and has only one optical axis. The liquid crystal molecule 131 is a rod-type liquid crystal molecule or a discotic liquid crystal molecule according to its shape. In the rod-type liquid crystal molecule, a long axis thereof is an optical axis. In the discotic liquid crystal molecule 131, a short axis thereof is an optical axis. For example, the liquid crystal molecules 131 in the liquid crystal molecular layer 132 are all rod-type liquid crystal molecules.

It will be noted that in the embodiments of the present disclosure, an optical axis (e.g., the optical axis 1310 of the liquid crystal molecule 131) is also referred to as an optic axis. When light propagates in a crystal, a direction in which two orthogonal waves travels at the same speed is an extending direction of the optical axis, and there is no change in optical properties of light in this direction. For example, an anisotropic crystal has a birefringent effect on light propagating in the anisotropic crystal. However, when the light propagates in the anisotropic crystal along an optical axis of the anisotropic crystal, the light is not birefringent. Therefore, the optical axis of the anisotropic crystal may also be defined as a direction in which light may propagate without birefringence.

In some examples, as shown in FIG. 1F, the liquid crystal layer 130 further includes a first alignment film 133 and a second alignment film 134. The first alignment film 133 and the second alignment film 134 are respectively disposed on two sides of the liquid crystal molecular layer 132. For example, an alignment film (e.g., the first alignment film 133 or the second alignment film 134) is made of a polymer material, and the polymer material may be, for example, polyimide (PI).

The first alignment film 133 is configured to anchor liquid crystal molecules 131 in the liquid crystal molecular layer 132 close to the first alignment film 133, so that the liquid crystal molecules 131 close to the first alignment film 133 have a first pretilt angle. The second alignment film 134 is configured to anchor liquid crystal molecules 131 in the liquid crystal molecular layer 132 close to the second alignment film 134, so that the liquid crystal molecules 131 close to the second alignment film 134 have a second pretilt angle. In some examples, an alignment direction of the first alignment film 133 is the same as an alignment direction of the second alignment film 134.

It will be understood that the pretilt angle may cause the liquid crystal molecules 131 to be in a pretilt state, which means that the liquid crystal molecules 131 close to the alignment film (the first alignment film 133 or the second alignment film 134) are tilted in a particular direction with respect to a plane where the alignment film (the first alignment film 133 or the second alignment film 134) is located.

In some examples, the long axis of the rod-type liquid crystal molecule intersects with the plane where the alignment film is located, and the pretilt angle refers to an included angle between the long axis of the rod-type liquid crystal molecule and the alignment direction of the alignment film. The pretilt angles presented by the liquid crystal molecules 131 are an included angle (i.e., the first pretilt angle) between the long axis of the liquid crystal molecule 131 close to the first alignment film 133 and the alignment direction of the first alignment film 133 and an included angle (i.e., the second pretilt angle) between the long axis of the liquid crystal molecule 131 close to the second alignment film 134 and the alignment direction of the second alignment film 134 in states presented by the liquid crystal molecules 131, when the liquid crystal display panel 100 is not energized or when a voltage between the pixel electrode V2 and the common electrode V1 is 0.

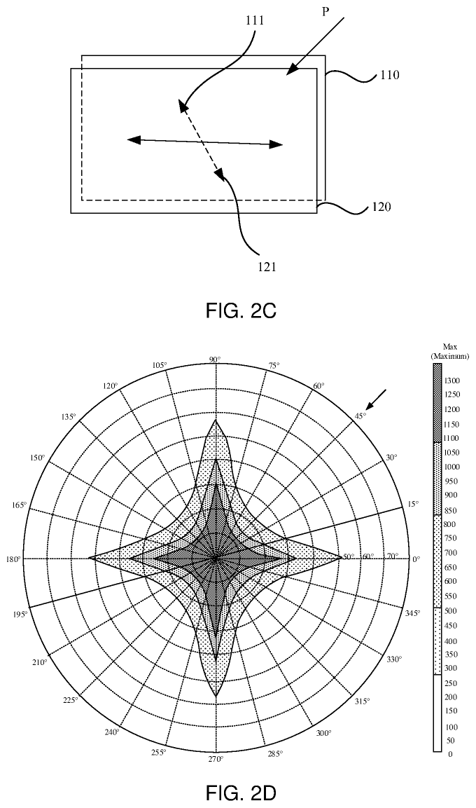

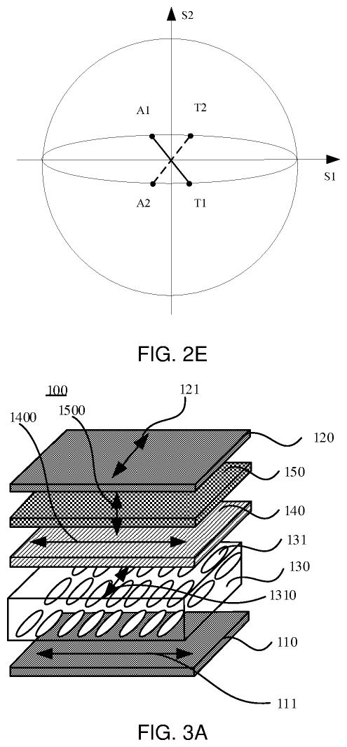

FIG. 2A is a structural diagram of a liquid crystal display panel, in accordance with yet other embodiments. FIG. 2B is a structural diagram of a liquid crystal display panel, in accordance with yet other embodiments.

In some examples, as shown in FIGS. 2A and 2B, orthographic projections of the optical axes of the liquid crystal molecules 131 on the first polarizer 110 are parallel to the transmission axis 111 of the first polarizer 110 or the transmission axis 121 of the second polarizer 120.

It will be understood that the orthographic projections of the optical axes of the liquid crystal molecules 131 on the first polarizer 110 are parallel to or approximately parallel to the transmission axis 111 of the first polarizer 110. Alternatively, the orthographic projections of the optical axes of the liquid crystal molecules 131 on the first polarizer 110 are parallel to or approximately parallel to the orthographic projection of the transmission axis 121 of the second polarizer 120 on the first polarizer 110.

It can be seen from the above that the transmission axis 111 of the first polarizer 110 is perpendicular to the transmission axis 121 of the second polarizer 120.

Therefore, in some examples, as shown in FIG. 2A, the orthographic projections of the optical axes of the liquid crystal molecules 131 on the first polarizer 110 are parallel to the transmission axis 121 of the second polarizer 120, i.e., are parallel to the orthographic projection of the transmission axis 121 of the second polarizer 120 on the first polarizer 110. Accordingly, the orthographic projections of the optical axes of the liquid crystal molecules 131 on the first polarizer 110 are perpendicular to the transmission axis 111 of the first polarizer 110.

In some other examples, as shown in FIG. 2B, the orthographic projections of the optical axes of the liquid crystal molecules 131 on the first polarizer 110 are parallel to the transmission axis 111 of the first polarizer 110. Accordingly, the orthographic projections of the optical axes of the liquid crystal molecules 131 on the first polarizer 110 are perpendicular to the transmission axis 121 of the second polarizer 120, i.e., are perpendicular to the orthographic projection of the transmission axis 121 of the second polarizer 120 on the first polarizer 110.

It can be seen from the above that the first polarizer 110 is closer to the light exit side of the backlight module 210 than the second polarizer 120. In some examples, as shown in FIG. 2A, an arrangement mode in which the orthographic projections of the optical axes of the liquid crystal molecules 131 on the first polarizer 110 are perpendicular to the transmission axis 111 of the first polarizer 110 may be referred to as an O mode. As shown in FIG. 2B, an arrangement mode in which the orthographic projections of the optical axes of the liquid crystal molecules 131 on the first polarizer 110 are parallel to the transmission axis 111 of the first polarizer 110 may be referred to as an E mode.

When no voltage is applied to the liquid crystal molecules 131 in the liquid crystal layer 130 (that is, the voltage between the pixel electrode V2 and the common electrode V1 is 0), the liquid crystal layer 130 may be regarded as a +A compensation film layer (also referred to as +A plate). In this case, if the backlight module 210 provides the light source normally, the liquid crystal display panel 100 is in an LO state, i.e., performs a dark state display (i.e., all-black display).

The optical axes of the liquid crystal molecules 131 are parallel to the transmission axis 111 of the first polarizer 110 or the transmission axis 121 of the second polarizer 120, so that after reaching the liquid crystal layer 130, the linearly polarized light passing through the first polarizer 110 is able to propagate in a thickness direction of the liquid crystal molecule 131, i.e., is able to propagate in a Z-axis direction of the liquid crystal molecule 131. It will be understood that light propagating in the Z-axis direction of the liquid crystal molecule 131 is not birefringent, or only a very small amount of light propagating in the Z-axis direction of the liquid crystal molecule 131 is birefringent. Therefore, when the liquid crystal display panel 100 is in the LO state, a light leakage phenomenon caused by the birefringence of the liquid crystal molecules 131 is not serious.

It can be seen from the above that as shown in FIG. 1C, the transmission axis 111 of the first polarizer 110 is perpendicular to the transmission axis 121 of the second polarizer 120. That is, the transmission axis 111 of the first polarizer 110 is perpendicular to the transmission axis 121 of the second polarizer 120 when viewed from a normal direction (i.e., a direction of a normal line that is perpendicular to or approximately perpendicular to the display side of the liquid crystal display panel 100) of the display side of the liquid crystal display panel 100, and the light passing through the first polarizer 110 is unable to pass through the second polarizer 120, so that the liquid crystal display panel 100 is able to realize the dark state display.

FIG. 2C is a diagram showing a relative positional relationship between a transmission axis of a first polarizer and a transmission axis of a second polarizer at a side viewing angle.

As shown in FIG. 2C, the transmission axis 111 of the first polarizer 110 is not perpendicular to the transmission axis 121 of the second polarizer 120 when viewed from a direction (i.e., at a side viewing angle, e.g., the P direction in FIG. 2C) deviated from the normal direction of the display side of the liquid crystal display panel 100. In this way, at the side viewing angle, the linearly polarized light passing through the first polarizer 110 has a component in the direction parallel to or approximately parallel to the transmission axis 121 of the second polarizer 120. That is, part of the linearly polarized light passing through the first polarizer 110 is able to pass through the second polarizer 120 at the side viewing angle, so that when the liquid crystal display panel 100 is in the dark state, the light leakage phenomenon exists at the side viewing angle, which affects the display effect of the liquid crystal display panel 100.

FIG. 2D is a distribution diagram of a contrast ratio at a full viewing angle.

For example, as shown in FIG. 2D, a plurality of concentric circles arranged in a direction away from a center represent different polar angles, and different points on each concentric circle represent different azimuth angles.

In some examples, as shown in FIG. 2D, at the side viewing angle, in an example where the azimuth angle is 45° (as indicated by the arrow in FIG. 2D), when the polar angle is gradually increased, the contrast ratio (CR) is continuously decreased. That is, in a case where the azimuth angle is unchanged, the larger the polar angle is, the lower the contrast ratio is, and the more serious the light leakage phenomenon of the liquid crystal display panel 100 is.

FIG. 2E is a diagram showing positions of light on the Poincaré sphere at a side viewing angle.

In some examples, in an example where the azimuth angle is 45° and the polar angle is 60°, in the O mode, when the liquid crystal display panel 100 is in the LO state, positions of light on the Poincare sphere at a side viewing angle are as shown in FIG. 2E.

It can be seen from the above that in some examples, the first polarizer 110 is closer to the light incident side of the liquid crystal display panel 100 than the second polarizer 120. That is, the light emitted from the backlight module 210 reaches the liquid crystal display panel 100 in the direction from the first polarizer 110 to the second polarizer 120.

In FIG. 2E, the A1 point is a position of polarized light with a polarization direction parallel to or approximately parallel to the absorption axis of the first polarizer 110. The T1 point is a position of polarized light with a polarization direction parallel to or approximately parallel to the transmission axis 111 of the first polarizer 110. The A2 point is a position of polarized light with a polarization direction parallel to or approximately parallel to the absorption axis of the second polarizer 120. The T2 point is a position of polarized light with a polarization direction parallel to or approximately parallel to the transmission axis 121 of the second polarizer 120.

It can be seen from FIG. 2E that the T1 point does not coincide with the A2 point. That is, the polarization direction of the linearly polarized light (the position of T1 in FIG. 2E) passing through the first polarizer 110 is not parallel to or approximately parallel to the absorption axis (the position of A2 in FIG. 2E) of the second polarizer 120. Thus, part of the linearly polarized light passing through the first polarizer 110 is able to pass through the second polarizer 120, so that when the liquid crystal display panel 100 is in the dark state, the light leakage phenomenon exists at the side viewing angle, which affects the display effect of the liquid crystal display panel 100.

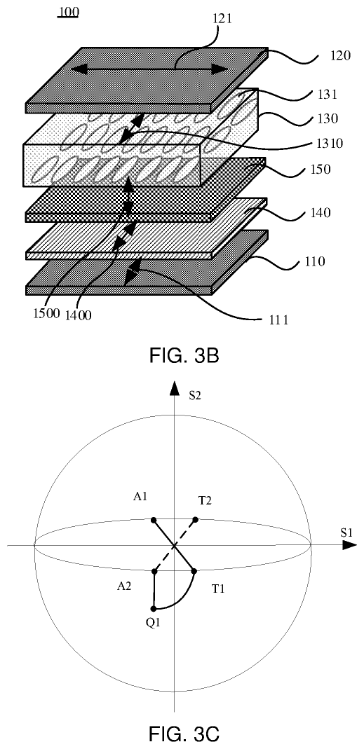

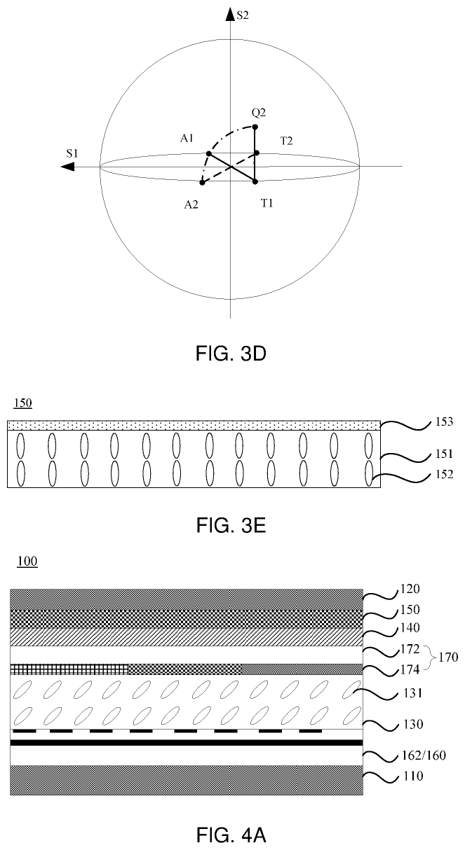

FIG. 3A is a structural diagram of a liquid crystal display panel, in accordance with yet other embodiments. FIG. 3B is a structural diagram of a liquid crystal display panel, in accordance with yet other embodiments.

In order to reduce the light leakage at the side viewing angle when the liquid crystal display panel 100 is in the dark state to improve the display effect of the liquid crystal display panel 100, as shown in FIGS. 3A and 3B, the embodiments of the present disclosure provide the liquid crystal display panel 100.

As shown in FIG. 3A, the liquid crystal display panel 100 includes the first polarizer 110, the second polarizer 120, the liquid crystal layer 130, a first optical compensation layer 140 and a second optical compensation layer 150. The second polarizer 120 and the first polarizer 110 are arranged opposite to each other. The transmission axis 111 of the first polarizer 110 is perpendicular to the transmission axis 121 of the second polarizer 120. The first polarizer 110 is closer to the light incident side of the liquid crystal display panel 100 than the second polarizer 120. The liquid crystal layer 130 is disposed between the first polarizer 110 and the second polarizer 120. The liquid crystal layer 130 includes the liquid crystal molecules 131, and the orthographic projections of the optical axes of the liquid crystal molecules 131 on the first polarizer 110 are parallel to the transmission axis 111 of the first polarizer 110 or the transmission axis 121 of the second polarizer 120.

It will be noted that the first polarizer 110, the second polarizer 120, the liquid crystal layer 130 and the liquid crystal molecules 131 in the liquid crystal layer 130 are exemplarily described in the above embodiments of the present disclosure, and will not be repeated here.

As shown in FIGS. 3A and 3B, the first optical compensation layer 140 and the second optical compensation layer 150 are stacked between the first polarizer 110 and the liquid crystal layer 130 or between the liquid crystal layer 130 and the second polarizer 120.

In some examples, as shown in FIG. 3A, the first optical compensation layer 140 and the second optical compensation layer 150 are stacked between the liquid crystal layer 130 and the second polarizer 120. In some other examples, as shown in FIG. 3B, the first optical compensation layer 140 and the second optical compensation layer 150 are stacked between the first polarizer 110 and the liquid crystal layer 130.

As shown in FIGS. 3A and 3B, an orthographic projection of an optical axis 1400 of the first optical compensation layer 140 on the first polarizer 110 is parallel to the transmission axis 111 of the first polarizer 110. Since the transmission axis 111 of the first polarizer 110 is perpendicular to the absorption axis of the first polarizer 110, the orthographic projection of the optical axis of the first optical compensation layer 140 on the first polarizer 110 is perpendicular to the absorption axis of the first polarizer 110. An optical axis 1500 of the second optical compensation layer 150 is perpendicular to a plane where the second optical compensation layer 150 is located.

In some examples, the orthographic projection of the optical axis of the first optical compensation layer 140 on the first polarizer 110 may be parallel to or approximately parallel to the transmission axis 111 of the first polarizer 110. For example, in a case where an acute angle between the orthographic projection of the optical axis of the first optical compensation layer 140 on the first polarizer 110 and the transmission axis 111 of the first polarizer 110 is less than or equal to 5°, the orthographic projection of the optical axis of the first optical compensation layer 140 on the first polarizer 110 may be considered as being parallel to the transmission axis 111 of the first polarizer 110.

It will be understood that the transmission axis 111 of the first polarizer 110 is parallel to the orthographic projection of the optical axis of the first optical compensation layer 140 on the first polarizer 110, so that the polarization direction of the linearly polarized light passing through the first polarizer 110 is able to be parallel to the optical axis of the first optical compensation layer 110. Thus, the first optical compensation layer 140 is able to compensate for the linearly polarized light passing through the first polarizer 110.

It will be understood that as shown in FIGS. 3A and 3B, the transmission axis 111 of the first polarizer 110 is perpendicular to the transmission axis 121 of the second polarizer 120, and the orthographic projection of the optical axis of the first optical compensation layer 140 on the first polarizer 110 is arranged to be parallel to the transmission axis 111 of the first polarizer 110, so that the orthographic projection of the optical axis of the first optical compensation layer 140 on the first polarizer 110 is able to be perpendicular to the orthographic projection of the transmission axis 121 of the second polarizer 120 on the first polarizer 110.

The optical axis of the second optical compensation layer 150 is perpendicular to the plane where the second optical compensation layer 150 is located. It will be understood that the optical axis of the second optical compensation layer 150 may be perpendicular to or approximately perpendicular to the plane where the second optical compensation layer 150 is located.

For example, in a case where an acute angle between the optical axis of the second optical compensation layer 150 and the plane where the second optical compensation layer 150 is located is greater than or equal to 88° (i.e., an obtuse angle between the optical axis of the second optical compensation layer 150 and the plane where the second optical compensation layer 150 is located is less than or equal to 92°), the optical axis of the second optical compensation layer 150 may be considered as being perpendicular to the plane where the second optical compensation layer 150 is located.

It will be understood that the first optical compensation layer 140 and the second optical compensation layer 150 are able to compensate for a phase retardation of the linearly polarized light passing through the first polarizer 110 at the side viewing angle to change a polarization state of the polarized light, so as to reduce an intensity of light passing through the second polarizer 120 at the side viewing angle when the liquid crystal display panel 100 is in the dark state, so that when the liquid crystal display panel 100 is in the dark state, the light leakage at the side viewing angle is able to be reduced, thereby improving the display effect of the liquid crystal display panel 100.

It will be understood that an optical axis of an optical compensation layer (e.g., the first optical compensation layer 140 or the second optical compensation layer 150) is a direction in which light has a maximum refractive index when reaching the optical compensation layer. Light has a smallest propagating speed in the optical axis of the optical compensation layer (e.g., the first optical compensation layer 140 or the second optical compensation layer 150).

In some examples, the first optical compensation layer 140 includes an anisotropic crystal layer with at least one optical axis. For example, the first optical compensation layer 140 may be an optical compensation layer with a single optical axis or an optical compensation layer with two optical axes. The second optical compensation layer 150 includes an anisotropic crystal layer with at least one optical axis. For example, the second optical compensation layer 150 is an optical compensation layer with a single optical axis, and has only one optical axis.

It can be seen from the above that the orthographic projection of the optical axis of the first optical compensation layer 140 on the first polarizer 110 is parallel to the transmission axis 111 of the first polarizer 110, so that the orthographic projection of the optical axis of the first optical compensation layer 140 on the first polarizer 110 is able to be perpendicular to the orthographic projection of the transmission axis 121 of the second polarizer 120 on the first polarizer 110. That is, the orthographic projection of the optical axis of the first optical compensation layer 140 on the first polarizer 110 is able to be parallel to an orthographic projection of the absorption axis of the second polarizer 120 on the first polarizer 110.

In some examples, as shown in FIG. 3A, the first optical compensation layer 140 and the second optical compensation layer 150 are stacked between the liquid crystal layer 130 and the second polarizer 120, so that a distance between the first optical compensation layer 140 and the second polarizer 120 is less than a distance between the first optical compensation layer 140 and the first polarizer 110. In this way, the orthographic projection of the optical axis of the first optical compensation layer 140 on the first polarizer 110 is parallel to the orthographic projection of the absorption axis of the second polarizer 120 on the first polarizer 110, so that a manufacturing process of the liquid crystal display panel 100 is able to be simplified, so as to reduce the cost of the liquid crystal display panel 100.

In some examples, an in-plane retardation R_{O1} of the first optical compensation layer 140 and an in-plane retardation R_{OLC} of the liquid crystal layer 130 satisfy a following

$${R}_{O 1} = {n}_{1} \times {R}_{OLC} + {m}_{1} {λ}_{1} .$$

Here, m₁ is an integer, n₁ is in a range of ¼ to ¾, inclusive, and λ₁ is in a range of 390 nm to 780 nm, inclusive.

It will be understood that R_{O1} is an in-plane phase retardation of the first optical compensation layer 140, i.e., a phase retardation generated in the plane of the first optical compensation layer 140 when light passes through the first optical compensation layer 140 in the normal direction (i.e., vertical direction).

In some examples, the in-plane phase retardation of the first optical compensation layer 140 is an actual retardation when the light passes through the first optical compensation layer 140 in the normal direction (i.e., vertical direction).

For example, R_{O1}=nₓ₁−n_{y1})×d₁. Here, nₓ₁ is a refractive index in an X₁ axis direction in the plane of the first optical compensation layer 140, n_{y1} is a refractive index in a Y₁ axis direction in the plane of the first optical compensation layer 140 that is perpendicular to the X₁ axis, and d₁ is a thickness of the first optical compensation layer 140.

It will be noted that in a case where the X₁ axis has a small tilt angle (e.g., a tilt angle within 5°) with respect to the first optical compensation layer 140, the X₁ axis may be considered to be disposed in the plane of the first optical compensation layer 140. In some examples, the tilt angle of the X₁ axis with respect to the first optical compensation layer 140 is within 2° to improve the compensation effect of the first optical compensation layer 140.

It will be understood that R_{OLC} is the in-plane phase retardation of the liquid crystal layer 130, i.e., a phase retardation generated in the plane of the liquid crystal layer 130 when light passes through the liquid crystal layer 130 in the normal direction (i.e., vertical direction). In some examples, the in-plane phase retardation of the liquid crystal layer 130 is an actual retardation when the light passes through the liquid crystal layer 130 in the normal direction (i.e., vertical direction).

For example, R_{OLC}=n_{xLC}−n_{yLC})×d_{LC}. Here, n_{xLC} is a refractive index in an X axis direction in the plane of the liquid crystal layer 130, n_{yLC} is a refractive index in a Y axis direction perpendicular to the X axis in the plane of the liquid crystal layer 130, and d_{LC} is a thickness of the liquid crystal layer 130. The X axis is the optical axis of the liquid crystal molecule 131 in the liquid crystal layer 130.

It will be noted that in a case where the X axis has a small tilt angle (e.g., a tilt angle within 4°) with respect to the liquid crystal layer 130, the X axis may be considered to be disposed in the plane of the liquid crystal layer 130.

m₁ is the integer. It will be understood that m₁ may be a positive integer, a negative integer, or 0.

n₁ is in the range of ¼ to ¾, inclusive. For example, a value of n₁ may be ¼, ½ or ¾.

In some examples, the smaller the difference between the value of n₁ and ½, the better the compensation effect of the first optical compensation layer 140.

λ₁ is in the range of 390 nm to 780 nm, inclusive. In some examples, λ₁ is a wavelength of the light emitted from the backlight module 210. For example, the light emitted from the backlight module 210 may be natural light. In some examples, λ₁ may be in a range of 400 nm to 700 nm or in a range of 500 nm to 600 nm. For example, λ₁ may be 450 nm, 550 nm, 650 nm, or 750 nm.

FIG. 3C is a diagram showing positions of light on the Poincaré sphere at a side viewing angle, in accordance with some other embodiments. FIG. 3D is a diagram showing positions of light on the Poincaré sphere at a side viewing angle, in accordance with yet other embodiments.

For example, as shown in FIG. 3A, in the O mode, the first optical compensation layer 140 and the second optical compensation layer 150 are stacked between the liquid crystal layer 130 and the second polarizer 120. Moreover, in a case where the optical axis of the first optical compensation layer 140 is parallel to the transmission axis 111 of the first polarizer 110, and is perpendicular to the transmission axis 121 of the second polarizer 120, positions of light on the Poincaré sphere at a side viewing angle are as shown in FIG. 3C.

It can be seen from the above that in some examples, the first polarizer 110 is closer to the light incident side of the liquid crystal display panel 100 than the second polarizer 120. That is, the light emitted from the backlight module 210 reaches the liquid crystal display panel 100 in the direction from the first polarizer 110 to the second polarizer 120.

In the example where the azimuth angle is 45° and the polar angle is 60°, in FIG. 3C, the A1 point is the position of the polarized light with the polarization direction parallel to or approximately parallel to the absorption axis of the first polarizer 110; the T1 point is the position of the polarized light with the polarization direction parallel to or approximately parallel to the transmission axis 111 of the first polarizer 110; the A2 point is the position of the polarized light with the polarization direction parallel to or approximately parallel to the absorption axis of the second polarizer 120; the T2 point is the position of the polarized light with the polarization direction parallel to or approximately parallel to the transmission axis 121 of the second polarizer 120.

It can be seen from FIG. 3C that after passing through the first optical compensation layer 140, the linearly polarized light at the T1 point is able to be converted into elliptically polarized light (as shown by the Q1 point in FIG. 3C). After passing through the second optical compensation layer 150, the elliptically polarized light is able to be converted into linearly polarized light again, and a polarization direction of the linearly polarized light is parallel to or approximately parallel to the absorption axis of the second polarizer 120, i.e., is perpendicular to or approximately perpendicular to the transmission axis 121 of the second polarizer 120 (as shown by the A2 point in FIG. 3C).

For another example, as shown in FIG. 3B, in the E mode, the first optical compensation layer 140 and the second optical compensation layer 150 are stacked between the first polarizer 110 and the liquid crystal layer 130. Moreover, in a case where the optical axis of the first optical compensation layer 140 is parallel to the transmission axis 111 of the first polarizer 110, and is perpendicular to the transmission axis 121 of the second polarizer 120, positions of light on the Poincaré sphere at a side viewing angle are as shown in FIG. 3D.

In the example where the azimuth angle is 45° and the polar angle is 60°, in FIG. 3D, the A1 point is the position of the polarized light with the polarization direction parallel to or approximately parallel to the absorption axis of the first polarizer 110; the T1 point is the position of the polarized light with the polarization direction parallel to or approximately parallel to the transmission axis 111 of the first polarizer 110; the A2 point is the position of the polarized light with the polarization direction parallel to or approximately parallel to the absorption axis of the second polarizer 120; the T2 point is the position of the polarized light with the polarization direction parallel to or approximately parallel to the transmission axis 121 of the second polarizer 120.

It can be seen from FIG. 3D that after passing through the first optical compensation layer 140, the linearly polarized light at the T1 point is able to be converted into elliptically polarized light (as shown by the Q2 point in FIG. 3D). After passing through the second optical compensation layer 150, the elliptically polarized light is able to be converted into linearly polarized light again, and a polarization direction of the linearly polarized light is parallel to or approximately parallel to the absorption axis of the second polarizer 120, i.e., is perpendicular to or approximately perpendicular to the transmission axis 121 of the second polarizer 120 (as shown by the A2 point in FIG. 3D).

It can be seen from FIGS. 3C and 3D that at the side viewing angle, due to the compensation effect of the first optical compensation layer 140 and the second optical compensation layer 150, the linearly polarized light passing through the first polarizer 110 is able to be converted into the linearly polarized light with the polarization direction parallel to or approximately parallel to the absorption axis of the second polarizer 120 (i.e., with the polarization direction perpendicular to or approximately perpendicular to the transmission axis 121 of the second polarizer 120), and thus cannot pass through the second polarizer 120, so that when the liquid crystal display panel 100 is in the dark state, the light leakage at the side viewing angle is reduced, thereby improving the visual effect of the liquid crystal display panel 100.

It can be seen from the above that in the embodiments of the present disclosure, by arranging the first optical compensation layer 140 and the second optical compensation layer 150, the phase retardation of the polarized light passing through the first optical compensation layer 140 and the second optical compensation layer 150 is compensated to change the polarization state of the polarized light, so that the linearly polarized light has the polarization direction capable of being rotated to be perpendicular to or approximately perpendicular to the transmission axis 121 of the second polarizer 120, and thus cannot pass through the second polarizer 120.

That is, by arranging the first optical compensation layer 140 and the second optical compensation layer 150, when the liquid crystal display panel 100 is in the dark state, the light leakage at the side viewing angle is able to be reduced, thereby improving the display effect of the liquid crystal display panel 100.

Moreover, in the embodiments of the present disclosure, the in-plane retardation R_{O1} of the first optical compensation layer 140 and the in-plane retardation R_{OLC} of the liquid crystal layer 130 are set to satisfy the formula R_{O1}=n₁×R_{OLC}+m₁λ₁. Here, m₁ is the integer, n₁ is in the range of ¼ to ¾, inclusive, and λ₁ is in the range of 390 nm to 780 nm, inclusive. Therefore, the compensation effect of the first optical compensation layer 140 on the linearly polarized light is improved, so that when the liquid crystal display panel 100 is in the dark state, the light leakage at the side viewing angle is reduced, thereby improving the display effect of the liquid crystal display panel 100.

In some examples, the first optical compensation layer 140 is an optical compensation film layer based on liquid crystal molecule coating, or an optical compensation film layer based on a stretched polymer film. The second optical compensation layer 150 is an optical compensation film layer based on liquid crystal molecule coating, or an optical compensation film layer based on a stretched polymer film. For example, the first optical compensation layer 140 may be the same as or different from the second optical compensation layer 150.

FIG. 3E is a structural diagram of a second optical compensation layer, in accordance with some embodiments.

In some examples, as shown in FIG. 3E, the second optical compensation layer 150 includes a compensation liquid crystal molecular layer 151 and a compensation alignment film 153. It will be understood that the compensation liquid crystal molecular layer 151 includes compensation liquid crystal molecules 152. The compensation alignment film 153 is used for anchoring compensation liquid crystal molecules 152 in the compensation liquid crystal molecular layer 151 close to the compensation alignment film 153, so that optical axes of the compensation liquid crystal molecules 152 are able to be perpendicular to or approximately perpendicular to the compensation liquid crystal molecular layer 151. It will be understood that the optical axis of the compensation liquid crystal molecule 152 is the optical axis of the second optical compensation layer 150.

For example, in a case where an acute angle between the optical axis of the compensation liquid crystal molecule 152 and the compensation liquid crystal molecular layer 151 is greater than or equal to 88° (i.e., an obtuse angle between the optical axis of the compensation liquid crystal molecule 152 and the compensation liquid crystal molecular layer 151 is less than or equal to 92°), the optical axis of the compensation liquid crystal molecule 152 may be considered as being perpendicular to the compensation liquid crystal molecular layer 151.

It can be seen from the above that as shown in FIG. 1B, the liquid crystal display panel 100 includes the array substrate 160 and the opposite substrate 170. The array substrate 160 includes the first substrate 162, and the opposite substrate 170 includes the second substrate 172. The first substrate 162 and the second substrate 172 are disposed between the first polarizer 110 and the second polarizer 120.

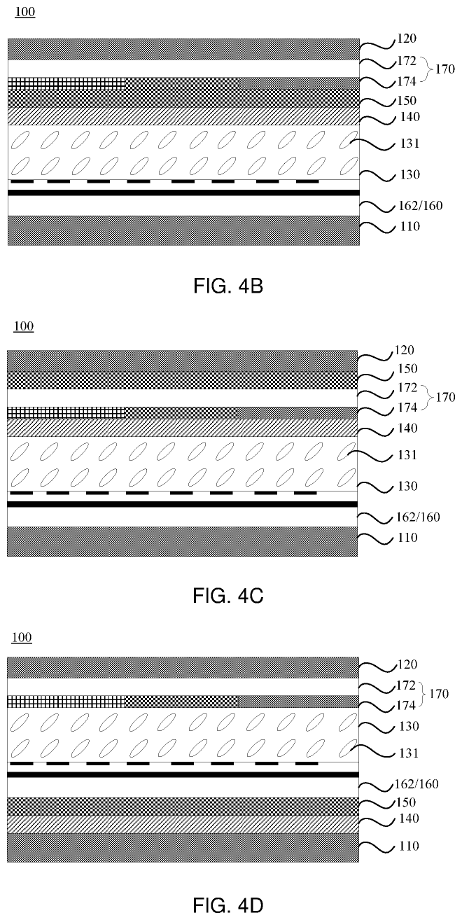

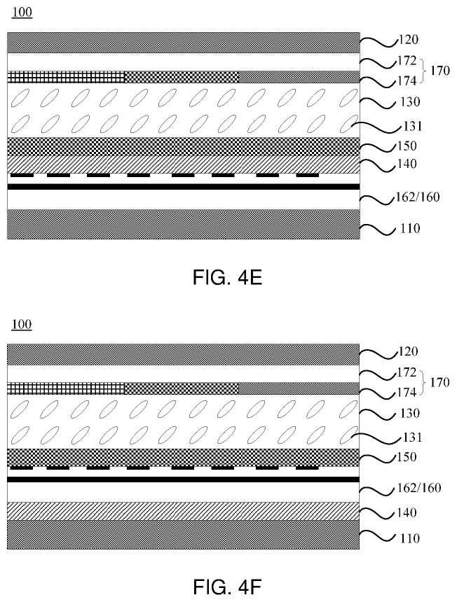

FIG. 4A is a structural diagram of a liquid crystal display panel, in accordance with yet other embodiments. FIG. 4B is a structural diagram of a liquid crystal display panel, in accordance with yet other embodiments. FIG. 4C is a structural diagram of a liquid crystal display panel, in accordance with yet other embodiments. FIG. 4D is a structural diagram of a liquid crystal display panel, in accordance with yet other embodiments. FIG. 4E is a structural diagram of a liquid crystal display panel, in accordance with yet other embodiments. FIG. 4F is a structural diagram of a liquid crystal display panel, in accordance with yet other embodiments. Positional relationships of the first substrate 162, the second substrate 172, the first optical compensation layer 140 and the second optical compensation layer 150 will be exemplarily described with reference to FIGS. 4A to 4F below.

In some examples, as shown in FIGS. 4A to 4C, the first optical compensation layer 140 and the second optical compensation layer 150 are disposed between the liquid crystal layer 130 and the second polarizer 120. In some examples, as shown in FIG. 4A, the first optical compensation layer 140 and the second optical compensation layer 150 are disposed on a side of the second substrate 172 away from the liquid crystal layer 130. In some other examples, as shown in FIG. 4B, the first optical compensation layer 140 and the second optical compensation layer 150 are disposed on a side of the second substrate 172 proximate to the liquid crystal layer 130. In yet other examples, as shown in FIG. 4C, one of the first optical compensation layer 140 and the second optical compensation layer 150 is disposed on the side of the second substrate 172 proximate to the liquid crystal layer 130, and another one of the first optical compensation layer 140 and the second optical compensation layer 150 is disposed on the side of the second substrate 172 away from the liquid crystal layer 130.

Similarly, in some other examples, as shown in FIGS. 4D to 4F, the first optical compensation layer 140 and the second optical compensation layer 150 are disposed between the first polarizer 110 and the liquid crystal layer 130. In some examples, as shown in FIG. 4D, the first optical compensation layer 140 and the second optical compensation layer 150 are disposed on a side of the first substrate 162 away from the liquid crystal layer 130. In some other examples, as shown in FIG. 4E, the first optical compensation layer 140 and the second optical compensation layer 150 are disposed on a side of the first substrate 162 proximate to the liquid crystal layer 130. In yet other examples, as shown in FIG. 4F, one of the first optical compensation layer 140 and the second optical compensation layer 150 is disposed on the side of the first substrate 162 proximate to the liquid crystal layer 130, and another one of the first optical compensation layer 140 and the second optical compensation layer 150 is disposed on the side of the first substrate 162 away from the liquid crystal layer 130.

It will be noted that the positional relationships of the first substrate 162, the second substrate 172, the first optical compensation layer 140 and the second optical compensation layer 150 are not further limited in the embodiments of the present disclosure.

In some embodiments, the value of n₁ is ½.

It will be understood that the value of n₁ is ½, i.e.,

$${R}_{O 1} = \frac{1}{2} \times {R}_{OLC} + {m}_{1} {λ}_{1} .$$

In some examples, a value of m₁ is 0. That is, the in-plane retardation R_{O1} of the first optical compensation layer 140 is equal to ½ R_{OLC}

$$( i . e . , {R}_{O 1} = \frac{1}{2} {R}_{OLC} ) .$$

In this way, the compensation effect of the first optical compensation layer 140 on the phase retardation of the linearly polarized light passing through the first polarizer 110 is improved, so as to change the polarization state of the polarized light, so that the polarization direction of the linearly polarized light is rotated to be perpendicular to or approximately perpendicular to the transmission axis 121 of the second polarizer 120, i.e., is rotated to be parallel to or approximately parallel to the absorption axis of the second polarizer 120. Thus, when the liquid crystal display panel 100 in the dark state, the light leakage at the side viewing angle is reduced, thereby improving the display effect of the liquid crystal display panel 100.

Moreover, as shown in FIG. 3C, the value of m₁ is set to be 0, so that the first optical compensation layer 140 is able to directly convert the linearly polarized light into the elliptically polarized light (i.e., the T1 point is converted into the Q1 point as shown in FIG. 3C), so that a path of the conversion process on the Poincaré sphere is shortened, and the process of converting the linearly polarized light into the elliptically polarized light is simplified. In this way, a manufacturing process of the first optical compensation layer 140 is able to be simplified, so as to reduce the production cost.

In some examples, a value of the in-plane retardation R_{OLC} of the liquid crystal layer 130 is ½λ₁. Based on this, the in-plane retardation R_{O1} of the first optical compensation layer 140 is equal to ¼λ₁

$$( i . e . , {R}_{O 1} = \frac{1}{4} {λ}_{1} ) .$$

It can be seen from the above that the first polarizer 110 is closer to the light incident side of the liquid crystal display panel 100 than the second polarizer 120. In some embodiments, the first optical compensation layer 140 is the optical compensation layer with the single optical axis. As shown in FIGS. 3A and 3B, the second optical compensation layer 150 is disposed on a side of the first optical compensation layer 140 away from the first polarizer 110.

The first optical compensation layer 140 is the optical compensation layer with the single optical axis. That is, the first optical compensation layer 140 includes only one optical axis.

The second optical compensation layer 150 is disposed on the side of the first optical compensation layer 140 away from the first polarizer 110. In some examples, as shown in FIG. 3A, in a case where the first optical compensation layer 140 and the second optical compensation layer 150 are stacked between the liquid crystal layer 130 and the second polarizer 120, the second optical compensation layer 150 is disposed between the first optical compensation layer 140 and the second polarizer 120. In some other examples, as shown in FIG. 3B, in a case where the first optical compensation layer 140 and the second optical compensation layer 150 are stacked between the first polarizer 110 and the liquid crystal layer 130, the second optical compensation layer 150 is disposed between the first optical compensation layer 140 and the liquid crystal layer 130.

The second optical compensation layer 150 is disposed on the side of the first optical compensation layer 140 away from the first polarizer 110, so that the linearly polarized light passing through the first polarizer 110 is able to be converted into the elliptically polarized light by the first optical compensation layer 140, and then the elliptically polarized light is converted into the linearly polarized light again by the second optical compensation layer 150. Moreover, the polarization direction of the linearly polarized light passing through the second optical compensation layer 150 is parallel to or approximately parallel to the absorption axis of the second polarizer 120 (that is, the polarization direction of the linearly polarized light passing through the second optical compensation layer 150 is perpendicular to or approximately perpendicular to the transmission axis 121 of the second polarizer 120).

In this way, when the liquid crystal display panel 100 is in the dark state, the intensity of the light passing through the second polarizer 120 at the side viewing angle is reduced, so that when the liquid crystal display panel 100 is in the dark state, the light leakage at the side viewing angle is reduced, thereby improving the display effect of the liquid crystal display panel 100.

In some embodiments, the in-plane retardation R_{O1} of the first optical compensation layer 140 is in a range of 105 nm to 145 nm, inclusive.

It will be understood that R_{O1} is the in-plane phase retardation of the first optical compensation layer 140. It can be seen from the above that the in-plane retardation R_{O1} of the first optical compensation layer 140 is equal to (nₓ₁−n_{y1})×d₁ (i.e., R_{O1}=nₓ₁−n_{y1})×d₁. In this way, by adjusting the refractive index nₓ₁ in the X₁ axis direction in the plane of the first optical compensation layer 140, the refractive index n_{y1} in the Y₁ axis direction in the plane of the first optical compensation layer 140 that is perpendicular to the X₁ axis, and the thickness d₁ of the first optical compensation layer 140, the in-plane retardation R_{O1} of the first optical compensation layer 140 is able to be adjusted, so that the in-plane retardation R_{O1} of the first optical compensation layer 140 may be in the range of 105 nm to 145 nm, inclusive.

In some examples, the in-plane retardation R_{O1} of the first optical compensation layer 140 may be in a range of 110 nm to 140 nm, 115 nm to 135 nm, 120 nm to 130 nm, or 123 nm to 127 nm.

In some examples, a value of the in-plane retardation R_{O1} of the first optical compensation layer 140 may be in a range of a difference between 125 nm and 15 nm to a sum of 125 nm and 15 nm (i.e., 125±15 nm), a difference between 125 nm and 10 nm to a sum of 125 nm and 10 nm (i.e., 125±10 nm), a difference between 125 nm and 5 nm to a sum of 125 nm and 5 nm (i.e., 125±5 nm), or a difference between 125 nm and 2 nm to a sum of 125 nm and 2 nm (i.e., 125±2 nm). It will be understood that in some examples, the smaller the difference between the value of the in-plane retardation R_{O1} of the first optical compensation layer 140 and 125 nm, the better the compensation effect of the first optical compensation layer 140.

In some examples, the value of the in-plane retardation R_{O1} of the first optical compensation layer 140 may be 108 nm, 112 nm, 118 nm, 125 nm, 128 nm, 132 nm, 138 nm, or 142 nm.

It will be understood that the in-plane retardation R_{O1} of the first optical compensation layer 140 is in the range of 105 nm to 145 nm, inclusive, i.e., the first optical compensation layer 140 is able to perform a forward in-plane phase compensation on light, so that the phase of the polarized light passing through the first optical compensation layer 140 may be delayed compared to the phase of the polarized light before passing through the first optical compensation layer 140.

A thickness direction retardation Rₜₕ₁ of the first optical compensation layer 140 is in a range of 42.5 nm to 82.5 nm, inclusive.

It will be understood that Rₜₕ₁ is a phase retardation of the first optical compensation layer 140 in a thickness direction of the first optical compensation layer 140, i.e., a phase retardation generated in the thickness direction of the first optical compensation layer 140 when light passes through the first optical compensation layer 140 in the normal direction (i.e., vertical direction).

For example, the thickness direction retardation Rₜₕ₁ of the first optical compensation layer 140 is equal to [(nₓ₁+n_{y1})/2−n_{z1}]×d₁ (i.e., Rₜₕ₁=[(nₓ₁+n_{y1})/2−n_{z1}]×d₁. Here, nₓ₁ is the refractive index in the X₁ axis direction in the plane of the first optical compensation layer 140, n_{y1} is the refractive index in the Y₁ axis direction in the plane of the first optical compensation layer 140 that is perpendicular to the X₁ axis, n_{z1} is a refractive index in the thickness direction (i.e., Z₁ axis direction) of the first optical compensation layer 140, and d₁ is the thickness of the first optical compensation layer 140.

It will be noted that in the case where the X₁ axis has a small tilt angle (e.g., a tilt angle within 5°) with respect to the first optical compensation layer 140, the X₁ axis may be considered to be disposed in the plane of the first optical compensation layer 140. In some examples, the tilt angle of the X₁ axis with respect to the first optical compensation layer 140 is within 2° to improve the compensation effect of the first optical compensation layer 140.

By adjusting the refractive index nₓ₁ in the X₁ axis direction in the plane of the first optical compensation layer 140, the refractive index n_{y1} in the Y₁ axis direction in the plane of the first optical compensation layer 140 that is perpendicular to the X₁ axis, the refractive index n_{z1} in the thickness direction (i.e., Z₁ axis direction) of the first optical compensation layer 140 and the thickness d₁ of the first optical compensation layer 140, the thickness direction retardation Rₜₕ₁ of the first optical compensation layer 140 is able to be adjusted, so that the thickness direction retardation Rₜₕ₁ of the first optical compensation layer 140 may be in the range of 42.5 nm to 82.5 nm, inclusive.

In some examples, the thickness direction retardation Rₜₕ₁ of the first optical compensation layer 140 may be in a range of 47.5 nm to 77.5 nm, 52.5 nm to 72.5 nm, 60.5 nm to 70.5 nm, or 60.5 nm to 64.5 nm.

In some examples, a value of the thickness direction retardation Rₜₕ₁ of the first optical compensation layer 140 may be in a range of a difference between 62.5 nm and 15 nm to a sum of 62.5 nm and 15 nm (i.e., 62.5±15 nm), a difference between 62.5 nm and 10 nm to a sum of 62.5 nm and 10 nm (i.e., 62.5±10 nm), a difference between 62.5 nm and 5 nm to a sum of 62.5 nm and 5 nm (i.e., 62.5±5 nm), or a difference between 62.5 nm and 2 nm to a sum of 62.5 nm and 2 nm (i.e., 62.5±2 nm). It will be understood that in some examples, the smaller the difference between the value of the thickness direction retardation Rₜₕ₁ of the first optical compensation layer 140 and 62.5 nm, the better the compensation effect of the first optical compensation layer 140.

In some examples, the value of the thickness direction retardation Rₜₕ₁ of the first optical compensation layer 140 may be 43 nm, 48 nm, 52 nm, 58 nm, 62.5 nm, 67 nm, 76 nm, or 80 nm.

It will be understood that the thickness direction retardation Rₜₕ₁ of the first optical compensation layer 140 is in the range of 42.5 nm to 82.5 nm, inclusive, i.e., the first optical compensation layer 140 is able to perform the forward phase compensation on light in the thickness direction of the first optical compensation layer 140, so that the phase of the polarized light passing through the first optical compensation layer 140 may be delayed compared to the phase of the polarized light before passing through the first optical compensation layer 140.

The in-plane retardation R_{O1} of the first optical compensation layer 140 is set to be in the range of 105 nm to 145 nm, and the thickness direction retardation Rₜₕ₁ of the first optical compensation layer is set to be in the range of 42.5 nm to 82.5 nm, so that the first optical compensation layer 140 is able to satisfy different compensation requirements, so as to improve an applicability of the first optical compensation layer 140.

In some embodiments, a thickness direction retardation Rₜₕ₂ of the second optical compensation layer 150 and the in-plane retardation R_{OLC} of the liquid crystal layer 130 satisfy a following formula:

$${R}_{th 2} = {n}_{2} \times {R}_{OLC} + {m}_{2} {λ}_{2} .$$

Here, m₂ is an integer, n₂ is in a range of

$$- \frac{6 + π}{6 π} to - \frac{6 - π}{6 π} ,$$

inclusive, and λ₂ is in the range of 390 nm to 780 nm, inclusive.

It will be understood that Rₜₕ₂ is a phase retardation of the second optical compensation layer 150 in a thickness direction of the second optical compensation layer 150, i.e., a phase retardation generated in the thickness direction of the second optical compensation layer 150 when light passes through the second optical compensation layer 150 in the normal direction (i.e., vertical direction).

For example, the thickness direction retardation Rₜₕ₂ of the second optical compensation layer 150 is equal to (i.e., [(nₓ₂÷n_{y2})/2−n_{z2}]×d₂ (i.e., Rₜₕ₂=[(nₓ₂+n_{y2})/2−n_{z2}]×d₂. Here, nₓ₂ is a refractive index in an X₂ axis direction in the plane of the second optical compensation layer 150, n_{y2} is a refractive index in a Y₂ axis direction in the plane of the second optical compensation layer 150 that is perpendicular to the X₂ axis, n_{z2} is a refractive index in the thickness direction (i.e., Z₂ axis direction) of the second optical compensation layer 150, and d₂ is a thickness of the second optical compensation layer 150.

m₂ is the integer. It will be understood that m₂ may be a positive integer, a negative integer, or 0.

n₂ is in the range of

$$- \frac{6 + π}{6 π} to - \frac{6 - π}{6 π} ,$$

inclusive. For example, a value of n₂ may be

$$- \frac{3}{2 π} , - \frac{1}{π} , or - \frac{1}{2 π} .$$

In some examples, the smaller the difference between the value of n₂ and

$$- \frac{1}{π} ,$$

the better the compensation effect of the second light compensation layer 150.

λ₂ in the range of 390 nm to 780 nm, inclusive. In some examples, λ₂ is the wavelength of the light emitted from the backlight module 210. For example, the light emitted from the backlight module 210 may be natural light. In some examples, λ₂ may be in a range of 400 nm to 700 nm or 500 nm to 600 nm. For example, a value of A2 may be 450 nm, 550 nm, 650 nm or 750 nm.

In this way, the compensation effect of the second optical compensation layer 150 on the linearly polarized light is improved, so that when the liquid crystal display panel 100 is in the dark state, the light leakage at the side viewing angle is reduced, thereby improving the display effect of the liquid crystal display panel 100.

In some embodiments, the value of n₂ is

$$- \frac{1}{π} .$$

It will be understood that the value of n₂ is

$$- \frac{1}{π} , i . e . , {R}_{th 2} = - \frac{1}{π} \times {R}_{OLC} + {m}_{2} {λ}_{2} .$$

In some examples, a value of m₂ is 0. That is, the thickness direction retardation Rₜₕ₂ of the second optical compensation layer 150 is equal to

$$- \frac{1}{π} {R}_{OLC} ( i . e . , {R}_{th 2} = - \frac{1}{π} {R}_{OLC} ) .$$

In this way, the compensation effect of the second optical compensation layer 150 on the phase retardation of the linearly polarized light passing through the first polarizer 110 is improved, so as to change the polarization state of the polarized light, so that the polarization direction of the linearly polarized light is rotated to be perpendicular to or approximately perpendicular to the transmission axis 121 of the second polarizer 120. Thus, when the liquid crystal display panel 100 is in the dark state, the light leakage at the side viewing angle is reduced, thereby improving the display effect of the liquid crystal display panel 100.

Moreover, as shown in FIG. 3C, the value of m₂ is set to be 0, so that the second optical compensation layer 150 is able to directly convert the elliptically polarized light into the linearly polarized light, and the polarization direction of the linearly polarized light is parallel to or approximately parallel to the absorption axis of the second polarizer 120 (i.e., the Q1 point is converted into the A2 point as shown in FIG. 3C), so that a path of the conversion process on the Poincaré sphere is shortened, and the process of converting the elliptically polarized light into the linearly polarized light is simplified. In this way, a manufacturing process of the second optical compensation layer 150 is able to be simplified, so as to reduce the production cost.

In some examples, the value of the in-plane retardation R_{OLC} of the liquid crystal layer 130 is ½λ₂. Based on this, the thickness direction retardation Rₜₕ₂ of the second optical compensation layer 150 is equal to

$$- \frac{1}{2 π} {λ}_{2} ( i . e . , {R}_{th 2} = - \frac{1}{2 π} {λ}_{2} ) .$$

In some embodiments, the thickness direction retardation Rₜₕ₂ of the second optical compensation layer 150 is in a range of −100 nm to −60 nm, inclusive.

It can be seen from the above that the thickness direction retardation Rₜₕ₂ of the second optical compensation layer 150 is equal to [(nₓ₂÷n_{y2})/2−n_{z2}]×d₂, (i.e., Rₜₕ₂=[(nₓ₂+n_{y2})/2−n_{z2}]×d₂. It will be understood that by adjusting the refractive index nₓ₂ in the X₂ axis direction in the plane of the second optical compensation layer 150, the refractive index n_{y2} in the Y₂ axis direction in the plane of the second optical compensation layer 150 that is perpendicular to the X₂ axis, the refractive index n_{z2} in the thickness direction (i.e., Z₂ axis direction) of the second optical compensation layer 150 and the thickness d₂ of the second optical compensation layer 145, the thickness direction retardation Rₜₕ₂ of the second optical compensation layer 150 is able to be adjusted, so that the thickness direction retardation Rₜₕ₂ of the second optical compensation layer 150 may be in the range of −100 nm to −60 nm, inclusive.

In some examples, the thickness direction retardation Rₜₕ₂ of the second optical compensation layer 150 may be in a range of −95 nm to −65 nm, −90 nm to −70 nm, −85 to −75 nm, or −82 to −78 nm.

In some examples, a value of the thickness direction retardation Rₜₕ₂ of the second optical compensation layer 150 is in a range of a difference between −80 nm and 15 nm to a sum of −80 nm and 15 nm (i.e., −80±15 nm), a difference between −80 nm and nm to a sum of −80 nm and 10 nm (i.e., −80±10 nm), a difference between −80 nm and 5 nm to a sum of −80 nm and 5 nm (i.e., −80±5 nm), or a difference between −80 nm and 2 nm to a sum of −80 nm and 2 nm (i.e., −80±2 nm). It will be understood that in some examples, the smaller the difference between the value of the thickness direction retardation Rₜₕ₂ of the second optical compensation layer 150 and −80 nm, the better the compensation effect of the second optical compensation layer 150.

In some examples, the value of the thickness direction retardation Rₜₕ₂ of the second optical compensation layer 150 may be −93 nm, −80 nm, −76 nm, or −63 nm.

It will be understood that the thickness direction retardation Rₜₕ₂ of the second optical compensation layer 150 is in the range of −100 nm to −60 nm, inclusive, i.e., the second optical compensation layer 150 is able to perform a backward phase compensation on light in the thickness direction of the second optical compensation layer 150, so that the phase of the polarized light passing through the second optical compensation layer 150 may be advanced compared to the phase of the polarized light before passing through the second optical compensation layer 150.

The thickness direction retardation Rₜₕ₂ of the second optical compensation layer 150 is set to be in the range of −100 nm to −60 nm, inclusive, so that the second optical compensation layer 150 is able to satisfy different compensation requirements, so as to improve an applicability of the second optical compensation layer 150.

In some examples, a value of an in-plane retardation R_{O2} of the second optical compensation layer 150 is 0 nm. It will be understood that R_{O2} is an in-plane phase retardation of the second optical compensation layer 150, i.e., a phase retardation generated in the plane of the second optical compensation layer 150 when light passes through the second optical compensation layer 150 in the normal direction (i.e., vertical direction).

In some embodiments, the first optical compensation layer 140 is a +A compensation film layer, and the second optical compensation layer 150 is a +C compensation film layer.

The first optical compensation layer 140 is the +A compensation film layer (also referred to as +A plate). It will be understood that the +A compensation film layer satisfies that nₓ₁ is greater than n_{y1} that is approximately equal to n_{z1} (i.e., nₓ₁> n_{y1}≈n_{z1}), or nₓ₁ is greater than n_{y1} that is equal to n_{z1} (i.e., nₓ₁>n_{y1}=n_{z1}). Here, nₓ₁ is the refractive index in the X₁ axis direction in the plane of the +A compensation film layer, n_{y1} is the refractive index in the Y₁ axis direction in the plane of the +A compensation film layer that is perpendicular to the X₁ axis, and n_{z1} is the refractive index in the thickness direction (i.e. Z₁ axis direction) of the +A compensation film layer.

It will be noted that in a case where the X₁ axis has a small tilt angle (e.g., a tilt angle within 5°) with respect to the +A compensation film layer, the X₁ axis may be considered to be disposed in the plane of the +A compensation film layer. It will be understood that in the case where the X₁ axis has a small tilt angle with respect to the +A compensation film layer, n_{y1} and n_{z1} have a certain difference. Considering the above, n_{y1} may be equal to or approximately equal to n_{z1}.

The second optical compensation layer 150 is the +C compensation film layer (also referred to as +C plate). It will be understood that the +C compensation film layer satisfies that n_{z2} is greater than nₓ₂ that is approximately equal to n_{y2} (i.e., n_{z2}>nₓ₂≈n_{y2}), or n_{z2} is greater than n_{y2} that is equal to nₓ₂ (i.e., n_{z2}>ny2=nₓ₂). Here, n_{z2} is the refractive index in the thickness direction (i.e., Z₂ axis direction) of the +C compensation film layer, nₓ₂ is the refractive index in the X₂ axis direction in the plane of the +C compensation film layer, and n_{y2} is the refractive index in the Y₂ axis direction in the plane of the +C compensation film layer that is perpendicular to the X₂ axis.

It will be noted that in a case where the X₂ axis has a small tilt angle (e.g., a tilt angle within 5°) with respect to the +C compensation film layer, the X₂ axis may be considered to be disposed in the plane of the +C compensation film layer. It will be understood that in the case where the X₂ axis has a small tilt angle with respect to the +C compensation film layer, nₓ₂ and n_{y2} have a certain difference. Considering the above, nₓ₂ may be equal to or approximately equal to n_{y2}.

In some examples, the tilt angle of the X₂ axis with respect to the second optical compensation layer 150 is within 2°, so as to improve the compensation effect of the second optical compensation layer 150.

It can be seen from the above that in some embodiments, the second optical compensation layer 150 is disposed on the side of the first optical compensation layer 140 away from the first polarizer 110. That is, the +C compensation film layer is disposed on the side of the +A compensation film layer away from the first polarizer 110.

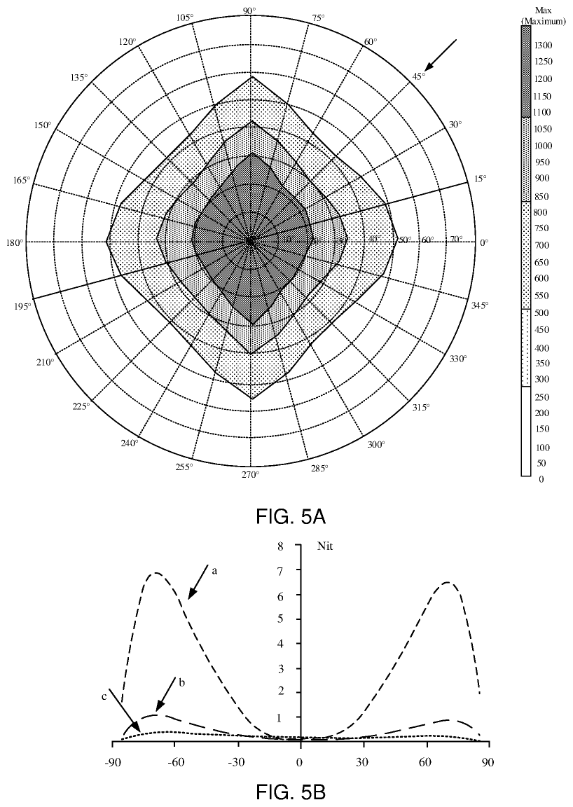

FIG. 5A is a distribution diagram of a contrast ratio at a full viewing angle, in accordance with some other embodiments.

For example, FIG. 5A is a distribution diagram of a contrast ratio of the liquid crystal display panel 100 at a full viewing angle in a case where the first optical compensation layer 140 is the +A compensation film layer and the second optical compensation layer 150 is the +C compensation film layer. As shown in FIG. 5A, a plurality of concentric circles arranged in a direction away from a center represent different polar angles, and different points on each concentric circle represent different azimuth angles.

In some examples, as shown in FIG. 5A, at the side viewing angle, in an example where the azimuth angle is 45° (as indicated by the arrow in FIG. 5A), the contrast ratio decreases slowly as the polar angle gradually increases. That is, compared to FIG. 2D, by arranging the +A compensation film layer and the +C compensation film layer, the contrast ratio is able to decrease slowly as the polar angle increases in a case where the azimuth angle is unchanged. Therefore, when the liquid crystal display panel 100 is in the dark state, the light leakage at the side viewing angle is reduced, thereby improving the display effect of the liquid crystal display panel 100.

For example, as shown in FIG. 5A, in a case where the azimuth angle is 0°, 90°, 180° or 270°, the contrast ratio is also able to decrease slowly as the polar angle increases, so that when the liquid crystal display panel 100 is in the dark state, the light leakage at the side viewing angle is reduced.

FIG. 5B is a graph of a light leakage brightness at a side viewing angle, in accordance with some embodiments.

As shown in FIG. 5B, Curve a is a curve of the light leakage brightness (with a unit of nit) varying with the polar angle at the side viewing angle when the liquid crystal display panel 100 without an optical compensation layer (e.g., the first optical compensation layer 140 or the second optical compensation layer 150) is in the dark state. Curve b is a curve of the light leakage brightness (with the unit of nit) varying with the polar angle at the side viewing angle when the liquid crystal display panel 100 with the +A compensation film layer and the +C compensation film layer is in the dark state. It can be seen from Curve a and Curve b that, by arranging the +A compensation film layer and the +C compensation film layer, when the liquid crystal display panel 100 is in the dark state, the light leakage brightness at the side viewing angle is greatly reduced, so that when the liquid crystal display panel 100 is in the dark state, the light leakage at the side viewing angle is reduced, thereby improving the display effect of the liquid crystal display panel 100.

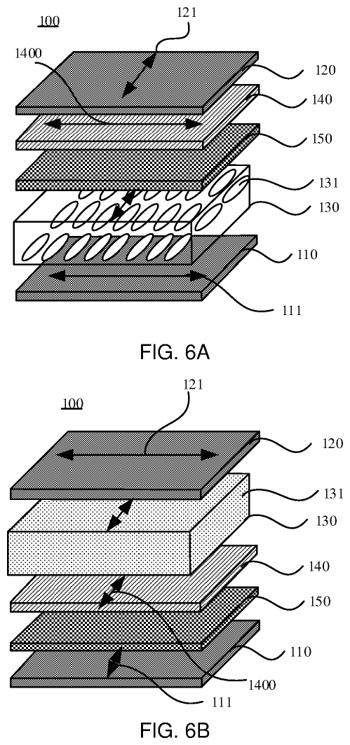

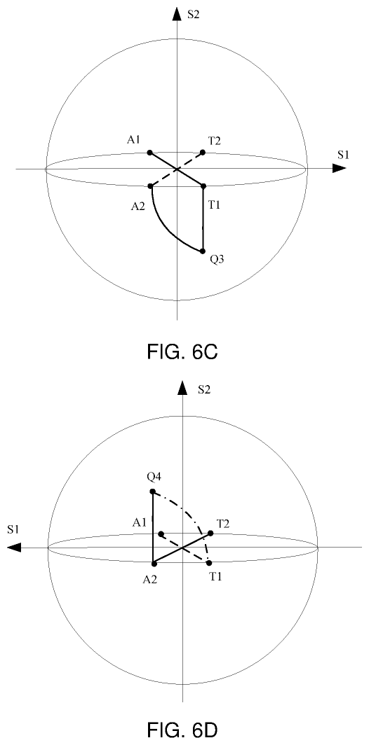

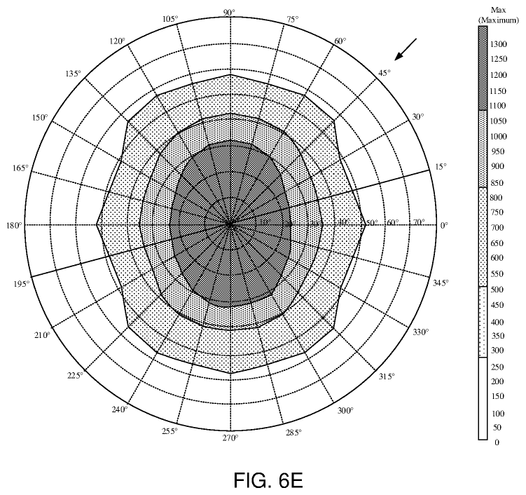

FIG. 6A is a structural diagram of a liquid crystal display panel, in accordance with yet other embodiments. FIG. 6B is a structural diagram of a liquid crystal display panel, in accordance with yet other embodiments.

It can be seen from the above that in some embodiments, the first polarizer 110 is closer to the light incident side of the liquid crystal display panel 100 than the second polarizer 120, and the second optical compensation layer 150 is disposed on the side of the first optical compensation layer 140 away from the first polarizer 110. In some other embodiments, as shown in FIGS. 6A and 6B, the second optical compensation layer 150 is disposed on a side of the first optical compensation layer 140 proximate to the first polarizer 110.

In some examples, as shown in FIG. 6A, in the case where the first optical compensation layer 140 and the second optical compensation layer 150 are stacked between the liquid crystal layer 130 and the second polarizer 120, the second optical compensation layer 150 is disposed between the first optical compensation layer 140 and the liquid crystal layer 130. In some other examples, as shown in FIG. 6B, in the case where the first optical compensation layer 140 and the second optical compensation layer 150 are stacked between the first polarizer 110 and the liquid crystal layer 130, the second optical compensation layer 150 is disposed between the first optical compensation layer 140 and the first polarizer 110.

The first optical compensation layer 140 is the optical compensation layer with two optical axes. The first optical compensation layer 140 includes a first optical axis 1400 and a second optical axis, and a length of the first optical axis is greater than a length of the second optical axis. An orthographic projection of the first optical axis on the first polarizer 110 is parallel to the transmission axis 111 of the first polarizer 110. That is, in the two optical axes of the first optical compensation layer 140, the orthographic projection of the longer optical axis on the first polarizer 110 is parallel to the transmission axis 111 of the first polarizer 110.

In some examples, the first optical axis is the X₁ axis in the plane of the first optical compensation layer 140. That is, the optical axis of the first optical compensation layer 140 is the X₁ axis in the plane of the first optical compensation layer 140.

In some examples, as shown in FIGS. 6A and 6B, the orthographic projection of the optical axis of the first optical compensation layer 140 on the first polarizer 110 may be parallel to or approximately parallel to the transmission axis 111 of the first polarizer 110.

For example, in a case where an acute angle between the orthographic projection of the optical axis of the first optical compensation layer 140 on the first polarizer 110 and the transmission axis 111 of the first polarizer 110 is less than or equal to 5°, the orthographic projection of the optical axis of the first optical compensation layer 140 on the first polarizer 110 may be considered to be parallel to the transmission axis 111 of the first polarizer 110. Since the transmission axis 111 of the first polarizer 110 is perpendicular to the absorption axis of the first polarizer 110, the orthographic projection of the optical axis of the first optical compensation layer 140 on the first polarizer 110 is perpendicular to the absorption axis of the first polarizer 110.

It will be understood that the transmission axis 111 of the first polarizer 110 is parallel to the orthographic projection of the optical axis of the first optical compensation layer 140 on the first polarizer 110, so that the polarization direction of the linearly polarized light passing through the first polarizer 110 is able to be parallel to the optical axis of the first optical compensation layer 140, and thus the first optical compensation layer 140 is able to compensate for the linearly polarized light passing through the first polarizer 110.

It will be understood that as shown in FIGS. 6A and 6B, since the transmission axis 111 of the first polarizer 110 is perpendicular to the transmission axis 121 of the second polarizer 120, the orthographic projection of the optical axis of the first optical compensation layer 140 on the first polarizer 110 is arranged to be parallel to the transmission axis 111 of the first polarizer 110, so that the orthographic projection of the optical axis of the first optical compensation layer 140 on the first polarizer 110 is able to be perpendicular to the orthographic projection of the transmission axis 121 of the second polarizer 120 on the first polarizer 110.

It will be understood that the first optical compensation layer 140 and the second optical compensation layer 150 are able to compensate for the phase retardation of the linearly polarized light passing through the first polarizer 110 at the side viewing angle to change the polarization state of the polarized light, so as to reduce the intensity of the light passing through the second polarizer 120 at the side viewing angle when the liquid crystal display panel 100 is in the dark state, so that when the liquid crystal display panel 100 is in the dark state, the light leakage at the side viewing angle is able to be reduced, thereby improving the display effect of the liquid crystal display panel 100.

It will be understood that an optical axis of an optical compensation layer (e.g., the first optical compensation layer 140 or the second optical compensation layer 150) is a direction in which light has a maximum refractive index when reaching the optical compensation layer. Light has a smallest propagating speed in the optical axis of the optical compensation layer (e.g., the first optical compensation layer 140 or the second optical compensation layer 150).

FIG. 6C is a diagram showing positions of light on the Poincaré sphere at a side viewing angle, in accordance with yet other embodiments. FIG. 6D is a diagram showing positions of light on the Poincaré sphere at a side viewing angle, in accordance with yet other embodiments.

For example, as shown in FIG. 6A, in the O mode, the first optical compensation layer 140 and the second optical compensation layer 150 are stacked between the liquid crystal layer 130 and the second polarizer 120. Moreover, in a case where the optical axis of the first optical compensation layer 140 is parallel to the transmission axis 111 of the first polarizer 110, and is perpendicular to the transmission axis 121 of the second polarizer 120, positions of light on the Poincaré sphere at a side viewing angle are as shown in FIG. 6C.

It can be seen from the above that in some examples, the first polarizer 110 is closer to the light incident side of the liquid crystal display panel 100 than the second polarizer 120. That is, the light emitted from the backlight module 210 reaches the liquid crystal display panel 100 in the direction from the first polarizer 110 to the second polarizer 120.

In the example where the azimuth angle is 45° and the polar angle is 60°, in FIG. 6C, the A1 point is the position of the polarized light with the polarization direction parallel to or approximately parallel to the absorption axis of the first polarizer 110; the T1 point is the position of the polarized light with the polarization direction parallel to or approximately parallel to the transmission axis 111 of the first polarizer 110; the A2 point is the position of the polarized light with the polarization direction parallel to or approximately parallel to the absorption axis of the second polarizer 120; the T2 point is the position of the polarized light with the polarization direction parallel to or approximately parallel to the transmission axis 121 of the second polarizer 120.

It can be seen from FIG. 6C that after passing through the second optical compensation layer 150, the linearly polarized light at the T1 point is able to be converted into elliptically polarized light (as shown by the Q3 point in FIG. 6C). After passing through the first optical compensation layer 140, the elliptically polarized light is able to be converted into linearly polarized light again, and a polarization direction of the linearly polarized light is parallel to or approximately parallel to the absorption axis of the second polarizer 120, i.e., is perpendicular to or approximately perpendicular to the transmission axis 121 of the second polarizer 120 (as shown by the A2 point in FIG. 6C).

For another example, as shown in FIG. 6B, in the E mode, the first optical compensation layer 140 and the second optical compensation layer 150 are stacked between the first polarizer 110 and the liquid crystal layer 130. Moreover, in a case where the optical axis of the first optical compensation layer 140 is parallel to the transmission axis 111 of the first polarizer 110, and is perpendicular to the transmission axis 121 of the second polarizer 120, positions of light on the Poincaré sphere at a side viewing angle are as shown in FIG. 6D.

In the example where the azimuth angle is 45° and the polar angle is 60°, in FIG. 6D, the A1 point is the position of the polarized light with the polarization direction parallel to or approximately parallel to the absorption axis of the first polarizer 110; the T1 point is the position of the polarized light with the polarization direction parallel to or approximately parallel to the transmission axis 111 of the first polarizer 110; the A2 point is the position of the polarized light with the polarization direction parallel to or approximately parallel to the absorption axis of the second polarizer 120; the T2 point is the position of the polarized light with the polarization direction parallel to or approximately parallel to the transmission axis 121 of the second polarizer 120.

It can be seen from FIG. 6D that after passing through the second optical compensation layer 150, the linearly polarized light at the T1 point is able to be converted into elliptically polarized light (as shown by the Q4 point in FIG. 6D). After passing through the first optical compensation layer 140, the elliptically polarized light is able to be converted into linearly polarized light again, and a polarization direction of the linearly polarized light is parallel to or approximately parallel to the absorption axis of the second polarizer 120, i.e., is perpendicular to or approximately perpendicular to the transmission axis 121 of the second polarizer 120 (as shown by the A2 point in FIG. 6D).

It can be seen from FIGS. 6C and 6D that at the side viewing angle, due to the compensation effect of the first optical compensation layer 140 and the second optical compensation layer 150, the linearly polarized light passing through the first polarizer 110 is able to be converted into the linearly polarized light with the polarization direction parallel to or approximately parallel to the absorption axis of the second polarizer 120 (i.e., with the polarization direction perpendicular to or approximately perpendicular to the transmission axis 121 of the second polarizer 120), and thus cannot pass through the second polarizer 120, so that when the liquid crystal display panel 100 is in the dark state, the light leakage at the side viewing angle is reduced, thereby improving the visual effect of the liquid crystal display panel 100.

It can be seen from the above that in the embodiments of the present disclosure, the second optical compensation layer 150 may be disposed on the side of the first optical compensation layer 140 away from the first polarizer 110, or may be disposed on the side of the first optical compensation layer 140 proximate to the first polarizer 110, so as to satisfy different compensation requirements, thereby improving the applicability of the liquid crystal display panel 100.

It can be seen from the above that the orthographic projection of the optical axis of the first optical compensation layer 140 on the first polarizer 110 is parallel to the transmission axis 111 of the first polarizer 110, so that the optical axis of the first optical compensation layer 140 is able to be perpendicular to the orthographic projection of the transmission axis 121 of the second polarizer 120 on the first polarizer 110. That is, the orthographic projection of the optical axis of the first optical compensation layer 140 on the first polarizer 110 is able to be parallel to the orthographic projection of the absorption axis of the second polarizer 120 on the first polarizer 110.

In some examples, as shown in FIG. 6A, the first optical compensation layer 140 and the second optical compensation layer 150 are stacked between the liquid crystal layer 130 and the second polarizer 120, so that the distance between the first optical compensation layer 140 and the second polarizer 120 is less than the distance between the first optical compensation layer 140 and the first polarizer 110. In this way, the orthographic projection of the optical axis of the first optical compensation layer 140 on the first polarizer 110 is parallel to the orthographic projection of the absorption axis of the second polarizer 120 on the first polarizer 110, so that the manufacturing process of the liquid crystal display panel 100 is able to be simplified, so as to reduce the cost of the liquid crystal display panel 100.

In some embodiments, the in-plane retardation R_{O1} of the first optical compensation layer 140 is in a range of 95 nm to 135 nm, inclusive.

It will be understood that, R_{O1} is the in-plane phase retardation of the first optical compensation layer 140. It can be seen from the above that the in-plane retardation R_{O1} of the first optical compensation layer 140 is equal to (i.e., R_{O1}=(nₓ₁−n_{y1})×d₁. It will be understood that by adjusting the refractive index nₓ₁ in the X₁ axis direction in the plane of the first optical compensation layer 140, the refractive index n_{y1} in the Y₁ axis direction in the plane of the first optical compensation layer 140 that is perpendicular to the X₁ axis, and the thickness d₁ of the first optical compensation layer 140, the in-plane retardation R_{O1} of the first optical compensation layer 140 is able to be adjusted, so that R_{O1} may be in the range of 95 nm to 135 nm, inclusive.

In some examples, the in-plane retardation R_{O1} of the first optical compensation layer 140 may be in a range of 100 nm to 130 nm, 105 nm to 125 nm, 110 nm to 120 nm, or 113 nm to 117 nm.

In some examples, the value of the in-plane retardation Rot of the first optical compensation layer 140 is in a range of a difference between 115 nm and 15 nm to a sum of 115 nm and 15 nm (i.e., 115±15 nm), a difference between 115 nm and 10 nm to a sum of 115 nm and 10 nm (i.e., 115±10 nm), a difference between 115 nm and 5 nm to a sum of 115 nm and 5 nm (i.e., 115±5 nm), or a difference between 115 nm and 2 nm to a sum of 115 nm and 2 nm (i.e., 115±2 nm). It will be understood that in some examples, the smaller the difference between the value of the in-plane retardation R_{O1} of the first optical compensation layer 140 and 115 nm, the better the compensation effect of the first optical compensation layer 140.

In some examples, the value of the in-plane retardation R_{O1} of the first optical compensation layer 140 may be 98 nm, 102 nm, 115 nm, 127 nm, or 132 nm.

It will be understood that the in-plane retardation R_{O1} of the first optical compensation layer 140 is in the range of 95 nm to 135 nm, inclusive, i.e., the first optical compensation layer 140 is able to perform the forward in-plane phase compensation on light, so that the phase of the polarized light passing through the first optical compensation layer 140 may be delayed compared to the phase of the polarized light before passing through the first optical compensation layer 140.

The thickness direction retardation Rₜₕ₁ of the first optical compensation layer 140 is in a range of −130 nm to −90 nm, inclusive.

It will be understood that Rₜₕ₁ is the phase retardation of the first optical compensation layer 140 in the thickness direction of the first optical compensation layer 140, i.e., the phase retardation generated in the thickness direction of the first optical compensation layer 140 when light passes through the first optical compensation layer 140 in the normal direction (i.e., vertical direction).

It can be seen from the above that the thickness direction retardation Rₜₕ₁ of the first optical compensation layer 140 is equal to [(nₓ₁+n_{y1})/2−n_{z1}]×d₁, (i.e., Rₜₕ₁=[(nₓ₁+n_{y1})/2−n_{z1}]×d₁. Here, nₓ₁ is the refractive index in the X₁ axis direction in the plane of the first optical compensation layer 140, n_{y1} is the refractive index in the Y₁ axis direction in the plane of the first optical compensation layer 140 that is perpendicular to the X₁ axis, n_{z1} is the refractive index in the thickness direction (i.e., Z₁ axis direction) of the first optical compensation layer 140, and d₁ is the thickness of the first optical compensation layer 140.

It will be noted that in the case where the X₁ axis has a small tilt angle (e.g., a tilt angle within 5°) with respect to the first optical compensation layer 140, the X₁ axis may be considered to be disposed in the plane of the first optical compensation layer 140. In some examples, the tilt angle of the X₁ axis with respect to the first optical compensation layer 140 is within 2° to improve the compensation effect of the first optical compensation layer 140.

It will be understood that by adjusting the refractive index nₓ₁ in the X₁ axis direction in the plane of the first optical compensation layer 140, the refractive index n_{y1} in the Y₁ axis direction in the plane of the first optical compensation layer 140 that is perpendicular to the X₁ axis, the refractive index n_{z1} in the thickness direction (i.e., Z₁ axis direction) of the first optical compensation layer 140 and the thickness d₁ of the first optical compensation layer 140, the thickness direction retardation Rₜₕ₁ of the first optical compensation layer 140 is able to be adjusted, so that Rₜₕ₁ may be in the range of −130 nm to −90 nm, inclusive.

In some examples, the thickness direction retardation Rₜₕ₁ of the first optical compensation layer 140 may be in a range of −105 nm to −75 nm, −100 nm to −80 nm, −95 nm to −85 nm, or −92 nm to −88 nm.

In some examples, the value of the thickness direction retardation Rₜₕ₁ of the first optical compensation layer 140 may be in a range of a difference between −110 nm and 15 nm to a sum of −110 nm and 15 nm (i.e., −110±15 nm), a difference between −110 nm and 10 nm to a sum of −110 nm and 10 nm (i.e., −110±10 nm), a difference between −110 nm and 5 nm to a sum of −110 nm and 5 nm (i.e., −110±5 nm), or a difference between −110 nm and 2 nm to a sum of −110 nm and 2 nm (i.e., −110±2 nm). It will be understood that in some examples, the smaller the difference between the value of the thickness direction retardation Rₜₕ₁ of the first optical compensation layer 140 and −110 nm, the better the compensation effect of the first optical compensation layer 140.

In some examples, the value of the thickness direction retardation Rₜₕ₁ of the first optical compensation layer 140 may be −128 nm, −113 nm, −110 nm, or −98 nm.

It will be understood that the thickness direction retardation Rₜₕ₁ of the first optical compensation layer 140 is in the range of −130 nm to −90 nm, inclusive, i.e., the first optical compensation layer 140 is able to perform a backward phase compensation on light in the thickness direction of the first optical compensation layer 140, so that the phase of the polarized light passing through the first optical compensation layer 140 may be advanced compared to the phase of the polarized light before passing through the first optical compensation layer 140.

The in-plane retardation R_{O1} of the first optical compensation layer 140 is set to be in the range of 95 nm to 135 nm, and the thickness direction retardation Rₜₕ₁ of the first optical compensation layer 140 is set to be in the range of −130 nm to −90 nm, so that the first optical compensation layer 140 is able to satisfy different compensation requirements, so as to improve the applicability of the first optical compensation layer 140.

In some embodiments, the thickness direction retardation Rₜₕ₂ of the second optical compensation layer 150 and the in-plane retardation R_{OLC} of the liquid crystal layer 130 satisfy a following formula:

$${R}_{th 2} = {n}_{3} \times {R}_{OLC} + {m}_{3} {λ}_{3} .$$

Here, m₃ is an integer, n₃ is in a range of

$$\frac{6 - π}{6 π} to \frac{6 + π}{6 π} ,$$

inclusive, and λ₃ is in a range of 390 nm to 780 nm, inclusive.

It will be understood that Rₜₕ₂ is the phase retardation of the second optical compensation layer 150 in the thickness direction of the second optical compensation layer 150, i.e., the phase retardation generated in the thickness direction of the second optical compensation layer 150 when light passes through the second optical compensation layer 150 in the normal direction (i.e., vertical direction).

It can be seen from the above that the thickness direction retardation Rₜₕ₂ of the second optical compensation layer 150 is equal to [(nₓ₂÷n_{y2})/2−n_{z2}]×d₂; (i.e., Rₜₕ₂=[(nₓ₂+n_{y2})/2−n_{z2}]×d₂. Here, nₓ₂ is the refractive index in the X₂ axis direction in the plane of the second optical compensation layer 150, n_{y2} is the refractive index in the Y₂ axis direction in the plane of the second optical compensation layer 150 that is perpendicular to the X₂ axis, n_{z2} is the refractive index in the thickness direction (i.e., Z₂ axis direction) of the second optical compensation layer 150, and d₂ is the thickness of the second optical compensation layer 150.

m₃ is an integer. It will be understood that m₃ may be a positive integer, a negative integer, or 0.

n₃ is in the range of

$$\frac{6 - π}{6 π} to \frac{6 + π}{6 π} ,$$

inclusive. For example, a value of n₃ may be

$$\frac{1}{2 π} , \frac{1}{π} , or \frac{3}{2 π} .$$

In some examples, the smaller the difference between the value of n₃ and

$$\frac{1}{π} ,$$

the better the compensation effect of the second light compensation layer 150.

λ₃ is in the range of 390 nm to 780 nm, inclusive. In some examples, λ₃ is the wavelength of the light emitted from the backlight module 210. For example, the light emitted from the backlight module 210 may be natural light. In some examples, λ3 may be in a range of 400 nm to 700 nm or 500 nm to 600 nm. For example, a value of λ₃ may be 450 nm, 550 nm, 650 nm or 750 nm.

In this way, the compensation effect of the second optical compensation layer 150 on the linearly polarized light is improved, so that when the liquid crystal display panel 100 is in the dark state, the light leakage at the side viewing angle is reduced, thereby improving the display effect of the liquid crystal display panel 100.

In some embodiments, the value of n₃ is

$$\frac{1}{π} .$$

It will be understood that the value of n₃ is

$$\frac{1}{π} , i . e . , {R}_{th 2} = \frac{1}{π} \times {R}_{OLC} + {m}_{3} {λ}_{3} .$$

In some examples, a value of m₃ is 0. That is, the thickness direction retardation Rₜₕ₂ of the second optical compensation layer 150 is equal to

$$\frac{1}{π} {R}_{OLC} ( i . e . , {R}_{th 2} = \frac{1}{π} {R}_{OLC} ) .$$

In this way, the compensation effect of the second optical compensation layer 150 on the phase retardation of the polarized light passing through the first polarizer 110 is improved, so as to change the polarization state of the polarized light, so that the polarization direction of the linearly polarized light is rotated to be perpendicular to or approximately perpendicular to the transmission axis 121 of the second polarizer 120. Thus, when the liquid crystal display panel 100 is in the dark state, the light leakage at the side viewing angle is reduced, thereby improving the display effect of the liquid crystal display panel 100.

Moreover, as shown in FIG. 6C, the value of m₃ is set to be 0, so that the second optical compensation layer 150 is able to directly convert the linearly polarized light into the elliptically polarized light (i.e., the T1 point is converted into the Q3 point as shown in FIG. 6C), so that a path of the conversion process on the Poincaré sphere is shortened, and the process of converting the linearly polarized light into the elliptically polarized light is simplified. In this way, the manufacturing process of the second optical compensation layer 150 is able to be simplified, so as to reduce the production cost.

In some examples, the value of the in-plane retardation R_{OLC} of the liquid crystal layer 130 is 2. Based on this, the thickness direction retardation Rₜₕ₂ of the second optical compensation layer 150 is equal to

$$\frac{1}{2 π} {λ}_{3} ( i . e . , {R}_{th 2} = \frac{1}{2 π} {λ}_{3} ) .$$

In some embodiments, the thickness direction retardation Rₜₕ₂ of the second optical compensation layer 150 is in a range of 90 nm to 130 nm, inclusive.

It can be seen from the above that the thickness direction retardation Rₜₕ₂ of the second optical compensation layer 150 is equal to [(nₓ₂÷n_{y2})/2−n_{z2}]×d₂ (i.e., Rₜₕ₂=[(nₓ₂+n_{y2})/2−n_{z2}]×d₂. It will be understood that by adjusting the refractive index nₓ₂ in the X₂ axis direction in the plane of the second optical compensation layer 150, the refractive index n_{y2} in the Y₂ axis direction in the plane of the second optical compensation layer 150 that is perpendicular to the X₂ axis, the refractive index n_{z2} in the thickness direction (i.e., Z₂ axis direction) of the second optical compensation layer 150 and the thickness d₂ of the second optical compensation layer 145, the thickness direction retardation Rₜₕ₂ of the second optical compensation layer 150 is able to be adjusted, so that the thickness direction retardation Rₜₕ₂ of the second optical compensation layer 150 may be in the range of 90 nm to 130 nm, inclusive.

In some examples, the thickness direction retardation Rₜₕ₂ of the second optical compensation layer 150 may be in a range of 95 nm to 125 nm, 100 nm to 120 nm, 105 to 115 nm, or 108 to 112 nm.

In some examples, the value of the thickness direction retardation Rₜₕ₂ of the second optical compensation layer 150 is in a range of a difference between 110 nm and 15 nm to a sum of 110 nm and 15 nm (i.e., 110±15 nm), a difference between 110 nm and nm to a sum of 110 nm and 10 nm (i.e., 110±10 nm), a difference between 110 nm and 5 nm to a sum of 110 nm and 5 nm (i.e., 110±5 nm), or a difference between 110 nm and 2 nm to a sum of 110 nm and 2 nm (i.e., 110±2 nm). It will be understood that in some examples, the smaller the difference between the value of the thickness direction retardation Rₜₕ₂ of the second optical compensation layer 150 and 110 nm, the better the compensation effect of the second optical compensation layer 150.

In some examples, the value of the thickness direction retardation Rₜₕ₂ of the second optical compensation layer 150 may be 98 nm, 110 nm, 118 nm, 128 nm, or 132 nm.

It will be understood that the thickness direction retardation Rₜₕ₂ of the second optical compensation layer 150 is in the range of 90 nm to 130 nm, inclusive, i.e., the second optical compensation layer 150 is able to perform a forward phase compensation on light in the thickness direction of the second optical compensation layer 150, so that the phase of the polarized light passing through the second optical compensation layer 150 may be delayed compared to the phase of the polarized light before passing through the second optical compensation layer 150.

The thickness direction retardation Rₜₕ₂ of the second optical compensation layer 150 is set to be in the range of 90 nm to 130 nm, inclusive, so that the second optical compensation layer 150 is able to satisfy different compensation requirements, so as to improve the applicability of the second optical compensation layer 150.

In some examples, the value of the in-plane retardation R_{O2} of the second optical compensation layer 150 is 0 nm. It will be understood that R_{O2} is the in-plane phase retardation of the second optical compensation layer 150, i.e., the phase retardation generated in the plane of the second optical compensation layer 150 when light passes through the second optical compensation layer 150 in the normal direction (i.e., vertical direction).

In some embodiments, the first optical compensation layer 140 is a +B compensation film layer, and the second optical compensation layer 150 is a −C compensation film layer.

The first optical compensation layer 140 is the +B compensation film layer (also referred to as +B plate). It will be understood that the +B compensation film layer satisfies that n_{z1} is less than n_{y1} that is less than nₓ₁ (i.e., n_{z1}<n_{y1}<nₓ₁). Here, nₓ₁ is the refractive index in the X₁ axis direction in the plane of the +B compensation film layer, n_{y1} is the refractive index in the Y₁ axis direction in the plane of the +B compensation film layer that is perpendicular to the X₁ axis, and n_{z1} is the refractive index in the thickness direction (i.e., Z₁ axis direction) of the +B compensation film layer.

It will be noted that in a case where the X₁ axis has a small tilt angle (e.g., a tilt angle within 5°) with respect to the +B compensation film layer, the X₁ axis may be considered to be disposed in the plane of the +B compensation film layer.

The second optical compensation layer 150 is the −C compensation film layer (also referred to as −C Plate). It will be understood that the −C compensation film layer satisfies that n_{z2} is less than nₓ₂ that is approximately equal to n_{y2} (i.e., n_{z2}<nₓ₂˜n_{y2}), or n_{z2} is less than nₓ₂ that is equal to n_{y2} (i.e., n_{z2}<nₓ₂=n_{y2}). Here, nₓ₂ is the refractive index in the X₂ axis direction in the plane of the −C compensation film layer, n_{y2} is the refractive index in the Y₂ axis direction in the plane of the −C compensation film layer that is perpendicular to the X₂ axis, and n_{z2} is the refractive index in the thickness direction (i.e., Z₂ axis direction) of the −C compensation film layer.

It will be noted that in a case where the X₂ axis has a small tilt angle (e.g., a tilt angle within 5°) with respect to the −C compensation film layer, the X₂ axis may be considered to be disposed in the plane of the −C compensation film layer. It will be understood that in the case where the X₂ axis has a small tilt angle with respect to the −C compensation film layer, n_{y2} and nₓ₂ have a certain difference. Considering the above, n_{y2} may be equal to or approximately equal to nₓ₂.

It can be seen from the above that in some embodiments, the second optical compensation layer 150 is disposed on the side of the first optical compensation layer 140 proximate to the first polarizer 110. That is, the −C compensation film layer is disposed on the side of the +B compensation film layer proximate to the first polarizer 110.

FIG. 6E is a distribution diagram of a contrast ratio at a full viewing angle, in accordance with yet other embodiments.

For example, FIG. 6E is a distribution diagram of a contrast ratio of the liquid crystal display panel 100 at a full viewing angle in a case where the first optical compensation layer 140 is the +B compensation film layer and the second optical compensation layer 150 is the −C compensation film layer. As shown in FIG. 6E, a plurality of concentric circles arranged in a direction away from a center represent different polar angles, and different points on each concentric circle represent different azimuth angles.

In some examples, as shown in FIG. 6E, in an example where the azimuth angle is 45° (as indicated by the arrow in FIG. 6E), the contrast ratio decreases slowly as the polar angle gradually increases. That is, compared to FIG. 2D, by arranging the +B compensation film layer and the −C compensation film layer, the contrast ratio is able to decrease slowly as the polar angle increases in a case where the azimuth angle is unchanged. Therefore, the light leakage of the liquid crystal display panel 100 is reduced, thereby improving the display effect of the liquid crystal display panel 100.

Moreover, it can be seen from FIG. 6E that in a case where the azimuth angle is 45°, 135°, 225° or 315°, the contrast ratio is also able to decrease slowly as the polar angle increases, so that the light leakage of the liquid crystal display panel 100 at the side viewing angle is reduced.

It can be seen from the above that as shown in FIG. 5B, Curve a is the curve of the light leakage brightness (with the unit of nit) varying with the polar angle at the side viewing angle when the liquid crystal display panel 100 without an optical compensation layer (e.g., the first optical compensation layer 140 or the second optical compensation layer 150) is in the dark state.

For example, Curve c is a curve of the light leakage brightness (with the unit of nit) varying with the polar angle at the side viewing angle when the liquid crystal display panel 100 with the +B compensation film layer and the −C compensation film layer is in the dark state.

It can be seen from Curve a and Curve c that, by arranging the +B compensation film layer and the −C compensation film layer, when the liquid crystal display panel 100 is in the dark state, the light leakage brightness at the side viewing angle is greatly reduced, so that when the liquid crystal display panel 100 is in the dark state, the light leakage at the side viewing angle is reduced, thereby improving the display effect of the liquid crystal display panel 100.

The display apparatus 200 provided in the embodiments of the present disclosure includes the liquid crystal display panel 100 as described above, and therefore has all of the above beneficial effects, which will not be repeated here.

The foregoing descriptions are only specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. A liquid crystal display panel, comprising:
a first polarizer;
a second polarizer arranged opposite to the first polarizer; wherein a transmission axis of the first polarizer is perpendicular to a transmission axis of the second polarizer; the first polarizer is closer to a light incident side of the liquid crystal display panel than the second polarizer;
a liquid crystal layer disposed between the first polarizer and the second polarizer and including liquid crystal molecules; orthographic projections of optical axes of the liquid crystal molecules on the first polarizer are parallel to the transmission axis of the first polarizer, or are parallel to the transmission axis of the second polarizer; and
a first optical compensation layer and a second optical compensation layer that are stacked between the first polarizer and the liquid crystal layer or between the liquid crystal layer and the second polarizer;
wherein an orthographic projection of an optical axis of the first optical compensation layer on the first polarizer is parallel to the transmission axis of the first polarizer; an optical axis of the second optical compensation layer is perpendicular to a plane where the second optical compensation layer is located; and
an in-plane retardation Ro of the first optical compensation layer and an in-plane retardation R_{OLC} of the liquid crystal layer satisfy a following formula:
$${R}_{O 1} = {n}_{1} \times {R}_{OLC} + {m}_{1} {λ}_{1} ;$$
wherein m₁ is an integer, n₁ is in a range of ¼ to ¾, inclusive and λ₁ is in a range of 390 nm to 780 nm, inclusive.

2. The liquid crystal display panel according to claim 1, wherein a value of n is ½.

3. The liquid crystal display panel according to claim 1, wherein the first optical compensation layer is an optical compensation layer with a single optical axis, and the second optical compensation layer is disposed on a side of the first optical compensation layer away from the first polarizer.

4. The liquid crystal display panel according to claim 3, wherein the in-plane retardation Rot of the first optical compensation layer is in a range of 105 nm to 145 nm, inclusive; and a thickness direction retardation Rₜₕ₁ of the first optical compensation layer is in a range of 42.5 nm to 82.5 nm, inclusive.

5. The liquid crystal display panel according to claim 3, wherein a thickness direction retardation Rₜₕ₂ of the second optical compensation layer and the in-plane retardation R_{OLC} of the liquid crystal layer satisfy a following formula:
$${R}_{th 2} = {n}_{2} \times {R}_{OLC} + {m}_{2} {λ}_{2} ;$$
wherein m₂ is an integer, n₂ is in a range of
$$- \frac{6 + π}{6 π} to - \frac{6 - π}{6 π} ,$$
inclusive, and λ₂ is in the range of 390 nm to 780 nm, inclusive.

6. The liquid crystal display panel according to claim 5, wherein a value of n₂ is
$$- \frac{1}{π} .$$

7. The liquid crystal display panel according to claim 3, wherein a thickness direction retardation Rₜₕ₂ of the second optical compensation layer is in a range of −100 nm to −60 nm, inclusive.

8. The liquid crystal display panel according to claim 3, wherein the first optical compensation layer is a +A compensation film layer, and the second optical compensation layer is a +C compensation film layer.

9. The liquid crystal display panel according to claim 1, wherein the second optical compensation layer is disposed on a side of the first optical compensation layer proximate to the first polarizer; the first optical compensation layer is an optical compensation layer with two optical axes; one of the two optical axes is a first optical axis, and a length of the first optical axis is greater than a length of another one of the two optical axes; an orthographic projection of the first optical axis on the first polarizer is parallel to the transmission axis of the first polarizer.

10. The liquid crystal display panel according to claim 9, wherein the in-plane retardation R_{O1} of the first optical compensation layer is in a range of 95 nm to 135 nm, inclusive; and a thickness direction retardation Rₜₕ₁ of the first optical compensation layer is in a range of −130 nm to −90 nm, inclusive.

11. The liquid crystal display panel according to claim 9, wherein a thickness direction retardation Rₜₕ₂ of the second optical compensation layer and the in-plane retardation R_{OLC} of the liquid crystal layer satisfy a following formula:
$${R}_{th 2} = {n}_{3} \times {R}_{OLC} + {m}_{3} {λ}_{3} ;$$
wherein m₃ is an integer, n₃ is in a range of
$$\frac{6 - π}{6 π} to \frac{6 + π}{6 π} ,$$
inclusive, and λ₃ is in the range of 390 nm to 780 nm, inclusive.

12. The liquid crystal display panel according to claim 11, wherein a value of n₃ is
$$\frac{1}{π} .$$

13. The liquid crystal display panel according to claim 9, wherein a thickness direction retardation Rₜₕ₂ of the second optical compensation layer is in a range of 90 nm to 130 nm, inclusive.

14. The liquid crystal display panel according to claim 9, wherein the first optical compensation layer is a +B compensation film layer, and the second optical compensation layer is a −C compensation film layer.

15. A display apparatus, comprising:
a backlight module; and
the liquid crystal display panel according to claim 1; wherein the liquid crystal display panel is disposed on a light exit side of the backlight module.

16. The liquid crystal display panel according to claim 1, wherein a value of m₁ is 0.

17. The liquid crystal display panel according to claim 4, wherein the in-plane retardation R_{O1} of the first optical compensation layer is in a range of a difference between 125 nm and 15 nm to a sum of 125 nm and 15 nm, a difference between 125 nm and 10 nm to a sum of 125 nm and 10 nm, a difference between 125 nm and 5 nm to a sum of 125 nm and 5 nm, or a difference between 125 nm and 2 nm to a sum of 125 nm and 2 nm; and the thickness direction retardation Rₜₕ₁ of the first optical compensation layer is in a range of a difference between 62.5 nm and 15 nm to a sum of 62.5 nm and 15 nm, a difference between 62.5 nm and 10 nm to a sum of 62.5 nm and 10 nm, a difference between 62.5 nm and 5 nm to a sum of 62.5 nm and 5 nm, or a difference between 62.5 nm and 2 nm to a sum of 62.5 nm and 2 nm.

18. The liquid crystal display panel according to claim 5, wherein a value of m₂ is 0.

19. The liquid crystal display panel according to claim 7, wherein the thickness direction retardation Rₜₕ₂ of the second optical compensation layer is in a range of a difference between −80 nm and 15 nm to a sum of −80 nm and 15 nm, a difference between −80 nm and 10 nm to a sum of −80 nm and 10 nm, a difference between −80 nm and 5 nm to a sum of −80 nm and 5 nm, or a difference between −80 nm and 2 nm to a sum of −80 nm and 2 nm.

20. The liquid crystal display panel according to claim 11, wherein a value of m₃ is 0.
